(19) United States
(12) Patent Application Publication
(10) Pub. No.: US 2025/0180226 A1
(43) Pub. Date: Jun. 5, 2025

(54) COOKING APPLIANCE

(71) Applicant: LG ELECTRONICS INC., Seoul (KR)

(72) Inventors: Jeahyuk WIE, Seoul (KR); Hyun Woo PARK, Seoul (KR); Doo Hyun KIM, Seoul (KR); Jeong JEONGHOON, Seoul (KR); Jeong-Woo KIM, Seoul (KR)

(21) Appl. No.: 18/945,883

(22) Filed: Nov. 13, 2024

(30) Foreign Application Priority Data
Dec. 1, 2023 (KR) 10-2023-0172530

(51) Int. Cl. F24C 15/34; F24C 3/08; F24C 15/00; F24C 15/18; F24C 15/32

(52) U.S. Cl. CPC F24C 15/34; F24C 3/085; F24C 15/006; F24C 15/322; F24C 15/18

(57) ABSTRACT

A cooking appliance is proposed. The cooling appliance includes an outer case (10) and a frame (60) disposed in the outer case. The frame (60) has a cooking chamber (S1). The cooking appliance includes a circulation device (C) having a circulation chamber (SA) connecting with the cooking chamber (S1). A heating device (100) includes a combustion chamber (S5) connected to the circulation chamber (SA). The heating device (100) includes a burner (120) heating air introduced into the combustion chamber (S5). At this point, the heating device (100) includes a first inlet part (IP1) open toward a surface of the burner (120). A second inlet part (IP2) connected to the combustion chamber (S5) is provided between the heating device (100) and the outer case (10).

### CROSS-REFERENCE TO RELATED APPLICATION(S)

The present application claims priority to Korean Patent Application No. 10-2023-0172530, filed in Korea on Dec. 1, 2023, the entire contents of which is incorporated herein for all purposes by this reference.

### BACKGROUND

### 1. Field

A cooking appliance is disclosed herein.

### 2. Background

Cooking appliances are a type of home appliance used to cook food or other items (hereinafter collectively “food”) and an appliance generally provided in a kitchen space. The cooking appliances may be classified in various ways according to a heat source, form, and type of fuel. When the cooking appliances are classified according to a form in which food is cooked, the cooking appliances may be classified into an open type and a sealed type according to a form of a space in which the food is placed. Sealed-type cooking appliances include ovens and microwave ovens, for example, and open type cooking appliances include cooktops and griddles, for example.

The sealed-type cooking appliances shield the space in which food is placed with doors and heat the shielded space to cook the food. The sealed type cooking appliance includes a cooking chamber in which the food is placed and which shields the food when it is cooked.

Among the sealed type cooking appliances, a cooking appliance using a gas burner as a heat source may include a burner to heat food inside of the cooking chamber. For example, a burner may be provided behind the cooking chamber to heat air. A convection fan may be provided behind the burner to transfer air heated by the burner evenly to the cooking chamber.

When the convection fan is operated, air is suctioned toward the convection fan, and a flame of the burner may face a rear wall surface of the cooking chamber. The wall of the cooking chamber may be overheated and a coating layer, such as an enamel layer, for example, may be damaged due to heat. To solve this problem, a separate protecting means, such as a burner reflector, to protect a wall surface of the cooking chamber from the heat of the burner is necessarily provided in the cooking appliance.

Further, a flow of the air suctioned by the convection fan may make the flame of the burner unstable. This problem may be solved by providing a separate stabilizer between the burner and the convection fan and preventing a flow of air caused by the convection fan from directly affecting the burner.

However, the existing cooking appliance needs a separate component, such as a burner reflector and a stabilizer, so the number of components and the manufacturing costs thereof increase. Further, it is difficult to design the cooking appliance due to the complexity of a heating device, which are problems.

As another method, a velocity of the convection fan may be reduced or the convection fan may be intermittently operated for a stability of a flame. However, as described above, when the velocity of the convection fan is reduced or the convection fan is intermittently operated, it is impossible to realize various cooking methods using the heating device, which is a disadvantage.

Further, an installation space for the heating device including the burner is required behind the existing cooking appliance. Accordingly, there is a problem in which the installation space of the heating device limits a frontward-rearward directional depth of the cooking chamber. In addition, due to a space occupied by additional components, such as a burner reflector and a stabilizer, a volume of the cooking chamber is reduced, which is a problem.

In addition, a fan cover that covers the convection fan should cover the heating device arranged at a rear side, so there is a limitation in reducing a size of the fan cover. Also, there is a problem in which it is difficult to perform a change in shape of the fan cover.

Further, the burner provided in the cooking appliance heats not only air in the heating chamber but also surrounding components, such as a burner cover of the heating chamber. More specifically, a frame of the cooking chamber may be changed by high temperature heat or an enamel coating layer of the frame may be damaged. As described above, when the burner heats surrounding components other than air, a durability of the surrounding components and a heat efficiency of the heating device are reduced, which is a problem.

At this point, the burner may overheat surrounding components, and there is not separate cooling device to prevent overheat of the surrounding components excluding the circulation fan, so the durability of the cooking appliance is deteriorated, which is a problem.

Furthermore, in order to generate stable flame, the burner of the cooking appliance should be supplied with not only primary air directly supplied to the burner, but also secondary air around a flame hole. However, the existing cooking appliance has a problem in that the secondary air is only efficiently supplied to a portion around the flame hole when the circulation fan is operated to generate a suction force, and supply of the secondary air is limited when the circulation fan is not operated. Accordingly, there is a limitation that the function to cook food by operating only the burner without operating the circulation fan is not provided.

### BRIEF DESCRIPTION OF THE DRAWINGS

The embodiments will be described in detail with reference to the following drawings in which like reference numerals refer to like elements wherein:

FIG. 1 is a perspective view of a cooking appliance according to an embodiment;

FIG. 2 is a perspective view of an inside space of a cooking chamber of an oven according to an embodiment;

FIG. 3 is a front view of the inside space of the cooking chamber of the oven without a cook-top and a drawer according to an embodiment;

FIG. 4 is a rear view of a rear side of the oven without the cook-top and the drawer according to an embodiment;

FIG. 5 is another rear view of the view of the oven of FIG. 4 without a cover plate;

FIG. 6 is an exploded perspective view of components of the oven according to an embodiment;

FIG. 7 is an exploded perspective view of a fan cover, a partition cover, a fan device, and a heating device of the oven according to an embodiment;

FIG. 8 is a front cross-sectional view taken by cutting a portion of the oven to expose the fan device and the heating device according to an embodiment;

FIG. 9 is a cross-sectional view, taken along line IX-IX′ of FIG. 2;

FIG. 10 is a cross-sectional view of a side structure of the oven and the drawer according to an embodiment;

FIG. 11 is an enlarged side view of a circulation device and the heating device of FIG. 10;

FIG. 12 is an enlarged perspective view of the circulation device and the heating device of FIG. 10;

FIG. 13 is a perspective view of the heating device according to an embodiment;

FIG. 14 is a perspective view of the heating device according to an embodiment at a different angle from FIG. 13;

FIG. 15 is a front view of a burner of the heating device according to an embodiment;

FIG. 16 is a plan view of the heating device according to an embodiment;

FIG. 17 is a rear view of the heating device according to an embodiment;

FIG. 18 is a cross-sectional view, taken along line XVIII-XVIII′ of FIG. 3;

FIG. 19 is a perspective view of the cross-sectional view of FIG. 18 at a different angle;

FIG. 20 is a perspective view of the cross-sectional view of FIG. 18 at a different angle from FIG. 19

FIG. 21 is a cross-sectional view, taken along line XXI-XXI of FIG. 3;

FIG. 22 is a perspective view of a rear lower structure of the oven according to an embodiment;

FIG. 23 is a cross-sectional view, taken along line XXIII-XXIII′ of FIG. 22;

FIG. 24 is a perspective view of a rear lower structure of the oven according to another embodiment;

FIG. 25 is a cross-sectional view, taken along line XXV-XXV′ of FIG. 24;

FIG. 26 is a cross-sectional view of a heating device according to another embodiment;

FIG. 27 is a cross-sectional view of a heating device according to another embodiment;

FIG. 28 is a perspective view of a burner and a guide duct of the heating device of FIG. 27;

FIG. 29 is a perspective view of a guide duct of the heating device of FIG. 27;

FIG. 30 is a side view of the guide duct of the heating device of FIG. 27;

FIG. 31 is a cross-sectional view of a heating device according to another embodiment;

FIG. 32 is a perspective view of a burner and guide duct of the heating device of FIG. 31;

FIG. 33 is a side view of the guide duct of the heating device of FIG. 31;

FIG. 34 is a plan view of a flame guide of a heating device according to another embodiment;

FIG. 35 is a cross-sectional view of a burner and the flame guide of the heating device of FIG. 34;

FIG. 36 is a plan view of a flame guide of a heating device according to another embodiment; and

FIG. 37 is a cross-sectional view of a burner and the flame guide of the heating device of FIG. 37.

### DETAILED DESCRIPTION

Hereinafter, embodiments will be described with reference to the illustrative drawings. Wherever possible, the same reference numerals will be used throughout the drawings and the description to refer to the same or like elements or parts. Further, it is to be noted that, when the description of functions and configuration of conventional elements related to the embodiments may make the gist unclear, detailed description of those elements will be omitted.

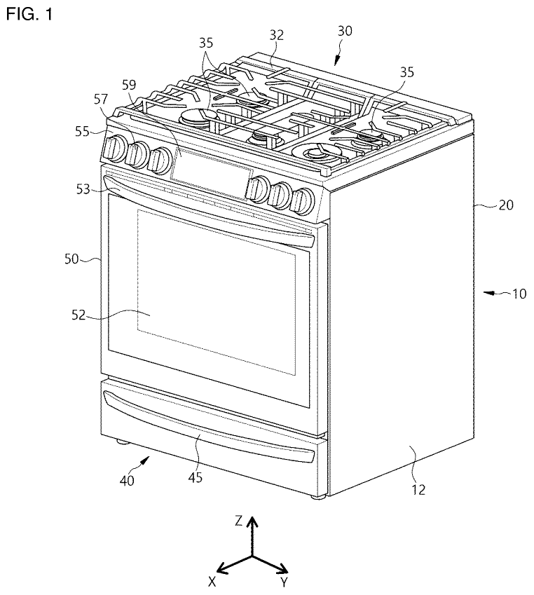

Embodiments relate to a cooking appliance. The cooking appliance may include a cooking chamber S1 therein. The cooking appliance may be a sealed cooking appliance in which the cooking chamber S1 is opened and closed by a door 50. Among terms described hereinafter, “a front side” may be a direction toward a user when the user is located in front of the cooking appliance. Referring to FIG. 1, an X-axial direction may be directed to the front side. A Y-axial direction may be a leftward-rightward width or lateral direction of the cooking chamber S1. A Z-axial direction may be a heightwise direction of the cooking chamber S1. Hereinafter, the cooking appliance will be described based on these directions.

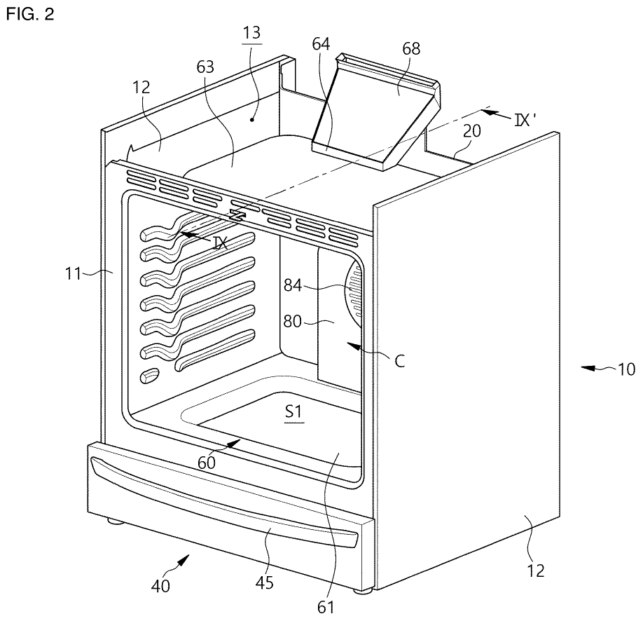

As shown in FIGS. 1 and 2, a frame of the cooking appliance may be formed by an outer case 10. The outer case 10 may be considered a portion exposed outside of the cooking appliance. The outer case 10 may have a roughly hexahedral structure or shape. An oven, which will be described hereinafter, may be disposed inside of the outer case 10.

In this embodiment, a cook-top 30 may be disposed at an upper portion of the cooking appliance, and a drawer 40 may be disposed at a lower portion thereof. The cook-top 30 may form an upper portion of the outer case 10. The drawer 40 may form a lower portion of the outer case 10. The oven may be disposed between the cook-top 30 and the drawer 40. As another example, the cook-top 30 or the drawer 40 may be omitted or both may be omitted.

The outer case 10 may have a roughly cuboid shape. The outer case 10 may be made of a material having a predetermined strength to protect multiple components installed inside of the outer case 10. The oven may be disposed inside of the outer case 10. The oven may be shielded by the outer case 10 and the door 50.

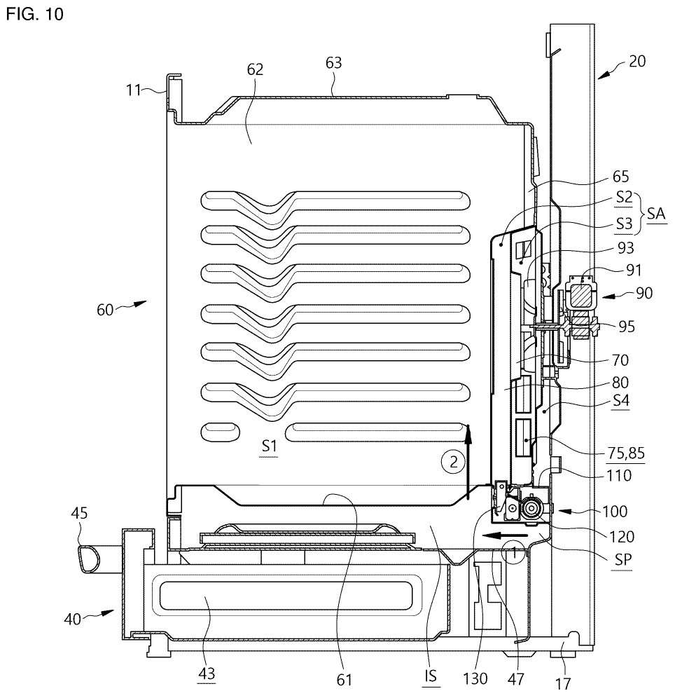

As shown in FIG. 2, the outer case 10 may include a front panel 11, a side panel 12, and a rear panel 20. The front panel 11 is a portion exposed when the door 50 is opened and may form a front surface of a frame 60. The side panel 12 may cover a left/right or first/second lateral surface of the frame 60. Referring to FIG. 10, a lower panel 17 of the outer case 10 may be provided at a lower portion of the drawer 40.

The front panel 11 may be coupled to a front surface of the frame 60, which will be described hereinafter. The front panel 11 may be disposed around edges of an opening of the cooking chamber S1 provided inside of the frame 60. When the door 50 is closed, a rear surface of the door 50 may be brought into close contact with the front panel 11.

The side panel 12 may be disposed on or at either side surface of the frame 60. The side panel 12 may be provided higher than a side surface of the frame 60. Accordingly, an electric chamber 13 may be provided between two side panels 12. The electric chamber 13 may provide a space in which electronic components are located, between the cook-top 30 and the oven. A control panel 55 may be located on or at a front surface of the electric chamber 13. The control panel 55 may shield the front surface of the electric chamber 13.

The rear panel 20 may be disposed behind the frame 60. The rear panel 20 may be coupled to the two side panels 12. The rear panel 20 may be spaced apart from a rear surface of the frame 60. Accordingly, the rear panel 20 and the rear surface of the frame 60 may be spaced apart from each other. This spacing may form an insulation space S4 (referring to FIG. 10) filled with an insulator. This structure will be described hereinafter.

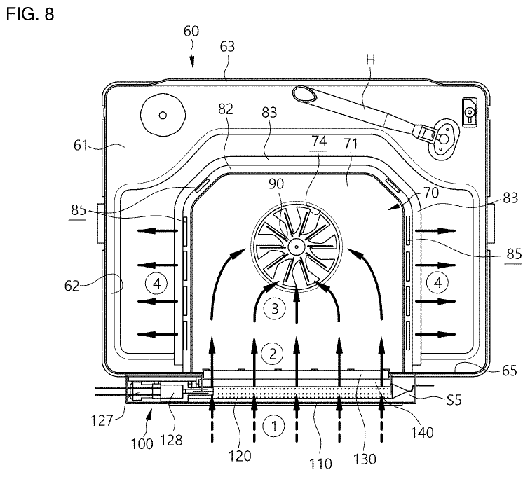

FIG. 4 is a rear view of the rear panel 20. Multiple holes may be provided on a surface of the rear panel 20. A motor (not illustrated) may be installed at some holes 25a of the multiple holes to lock the door 50. Another part or portion 25b of the holes may be connected to a pipe to supply fuel for a broil burner H (referring to FIG. 8) disposed at an upper portion of the cooking chamber S1, or may be a hole for installing a thermistor (not illustrated).

The rear panel 20 may include a panel opening 23. The panel opening 23 may be formed through the rear panel 20. The panel opening 23 may expose a heating device 100 provided inside of the outer case 10. The panel opening 23 may be provided at a height equal to a height of the heating device 100. The panel opening 23 may be provided lower than a bottom of the frame 60.

The panel opening 23 may be shielded by a shielding cover 28. FIG. 4 illustrates the panel opening 23 shielded by the shielding cover 28. In this embodiment, the shielding cover 28 does not fully shield the panel opening 23 and may allow a part or portion of the panel opening 23 to be open. Through the open portion, a part or portion of the heating device 100 including a nozzle holder 127 to spray gas to the burner 120 may be exposed.

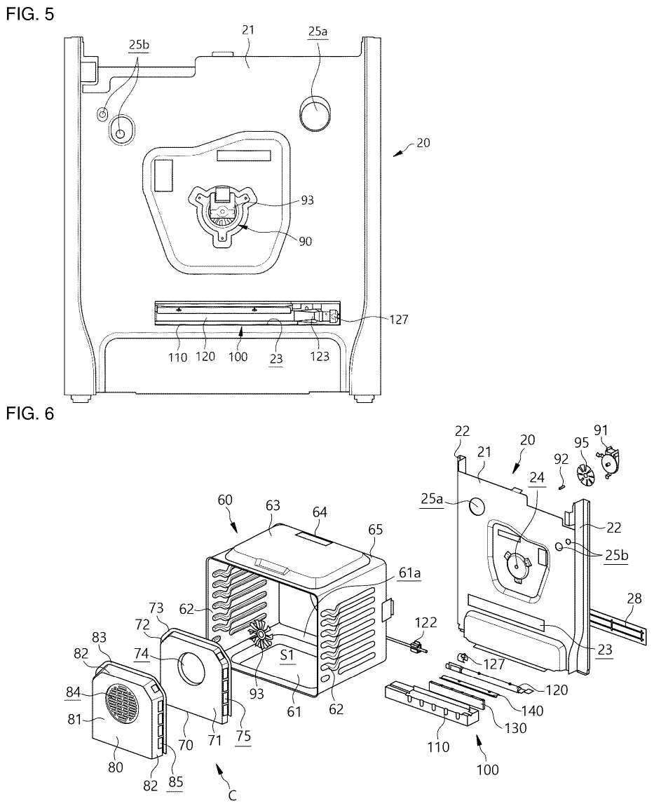

When the shielding cover 28 is removed as illustrated in FIG. 5, more of the heating device 100 may be exposed rearward. Most of the burner 120 of the heating device 100 may be exposed through the panel opening 23. A worker may remove the shielding cover 28 and access the heating device 100 to maintain the heating device 100. Further, the shielding cover 28 may be removed, and the burner 120 may be assembled to the heating device 100.

As described hereinafter, a burner case 110 may include a chamber opening 118 connected to the panel opening 23, and when the shielding cover 28 is removed, the worker may directly access a combustion chamber S5 which is an inside space of the burner case 110. As another example, the shielding cover 28 may be omitted. As another example, the shielding cover 28 may be coupled to the burner case 110 but not to the rear panel 20. The shielding cover 28 will be described hereinafter.

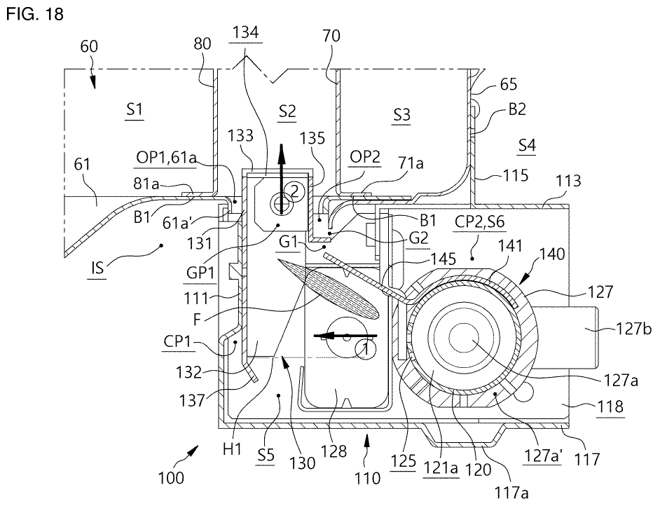

As shown in FIG. 1, the cook-top 30 may include multiple cook-top burners 35. The cook-top burners 35 may cook food by heating a container in which food is contained or directly cook food with a flame F (referring to FIG. 18) generated by burning gas. Reference numeral 32 indicates a top grate on which a container, for example, may be placed. As another example, the cook-top 30 may include one or more electric heaters. As another example, the cook-top 30 may include an induction heating (IH) burner that uses induced current caused by a magnetic field as a heat source. As another example, the cook-top 30 may be omitted.

The drawer 40 may include a drawer handle 45. The drawer 40 may slide forward and rearward from the outer case 10. The drawer 40 may keep a container containing food warm at a predetermined temperature. FIG. 10 illustrates a storage space 43 provided inside of the drawer 40 to store a container, for example. As another example, the drawer 40 may be omitted.

As shown in FIG. 1, the control panel 55 may be arranged in front of the cook-top 30. The control panel 55 may include a nob 57 to control the cook-top 30. The control panel 55 may include an operating part or portion 59 to control the oven and the drawer 40. The operating portion 59 may include a touch panel to display a state of the cooking appliance.

The door 50 may shield a front side of the cooking chamber S1. The door 50 may be operated in a kind of pull-down manner in which an upper end of the door is vertically swung about a lower end. As another example, the door 50 may be operated in a side swing manner in which the door is opened sideways. The door 50 may have structure that enables the cooking chamber S1 to be visible therethrough. For example, a front surface 52 of the door 50 may have a glass panel structure, and a user may observe the cooking chamber S1 through the door 50. As another example, the cooking chamber S1 may not be visible through the door 50 outside. Reference numeral 53 indicates a handle to open and close the door 50.

Referring to FIG. 2, a bottom surface of the electric chamber 13 may form an upper surface portion of the frame 60. The electric chamber 13 may include an exhaust duct 68. The exhaust duct 68 may be provided to discharge combustion gas out of the cooking appliance, the combustion gas being produced in the process of cooking food inside of the cooking chamber S1. A lower end of the exhaust duct 68 may be connected to an outlet port 64 open in an upper surface portion of the frame 60, and an upper end thereof may be disposed at an upper portion of a rear surface of the cooking appliance.

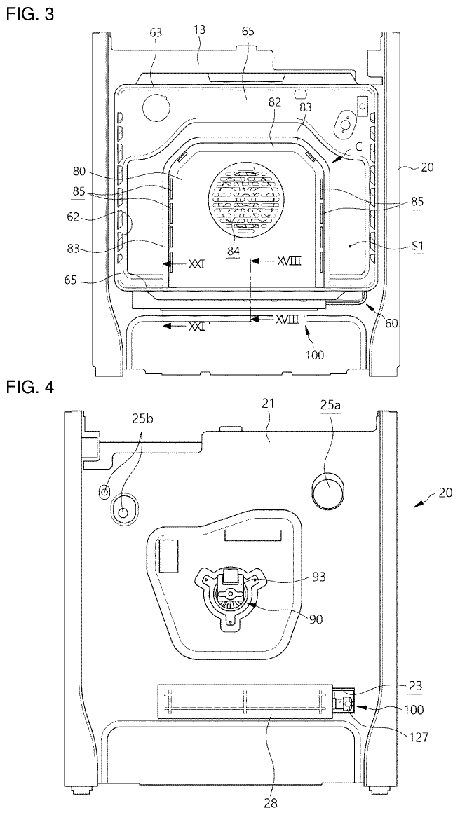

With reference to FIG. 3, the frame 60 may have a roughly hexahedral structure. The cooking chamber S1 may be provided inside of the frame 60. The cooking chamber S1 may have a roughly hexahedral structure similar to the frame 60. The frame 60 may be opened and closed by the outer case 10 and the door 50. Most of the surface of the frame 60 excluding the cooking chamber S1 may be covered by the outer case 10.

The frame 60 may include a frame lower surface 61 forming a bottom surface of the cooking chamber S1, a frame side surface 62 forming a side surface of the cooking chamber S1, a frame upper surface 63 forming an upper surface of the cooking chamber S1, and a frame rear surface 65 forming a rear surface of the cooking chamber S1. In addition, a front surface of the frame 60 may be open, and the cooking chamber S1 may be exposed.

In this embodiment, a circulation device C, which will be described hereinafter, may be disposed inside of the frame 60. The inside space of the frame 60 may be a space surrounded by the frame lower surface 61, the frame side surface 62, the frame upper surface 63, and the frame rear surface 65. The cooking chamber S1 may also be provided inside of the frame 60. The cooking chamber S1 may be provided in front of the circulation device C.

The heating device 100, which will be described hereinafter, may be arranged outside of the frame 60. An outside space of the frame 60 may be the outside space of the space surrounded by the frame lower surface 61, the frame side surface 62, the frame upper surface 63, and the frame rear surface 65. As described above, in this embodiment, the circulation device C and the heating device 100 may be arranged inside and outside of the frame 60.

Referring to FIG. 3, when the door 50 is opened, a cover plate 80 of the circulation device C, which will be described hereinafter, may be exposed inside of the cooking chamber S1. The cover plate 80 may be disposed in front of the frame rear surface 65 forming the rear surface of the cooking chamber S1. The cover plate 80 may be coupled to the frame rear surface 65 and may cover a partition plate 70 and a circulation fan 93. As described above, the circulation device C may be arranged inside of the cooking chamber S1 and may circulate air in the cooking chamber S1. For reference, a suction hole 84 of the cover plate 80 through which internal air of the cooking chamber S1 is suctioned, and second discharge holes 85 are provided to discharge heated air into the cooking chamber S1.

As illustrated in FIG. 3, the heating device 100 may be arranged at a lower portion of the frame 60. More specifically, the heating device 100 may be arranged lower than the frame lower surface 61. The circulation device C may be arranged inside of the cooking chamber S1, but the heating device 100 is arranged at the lower portion of the frame 60 which is outside of the cooking chamber S1. Referring to FIG. 10, the heating device 100 may be arranged between the frame lower surface 61 and a drawer cover 47 forming an upper surface of the drawer 40. When the drawer 40 is omitted, the heating device 100 may be arranged between the frame lower surface 61 and the lower panel 17.

FIG. 6 is an exploded view of the rear panel 20, the frame 60, the circulation device C, and the heating device 100. The circulation device C may suction internal air of the cooking chamber S1 and mix the air with high temperature air supplied from the heating device 100. The circulation device C may discharge the mixed air into the cooking chamber S1. These processes may be performed simultaneously and continuously, and the internal air of the cooking chamber S1 may be circulated.

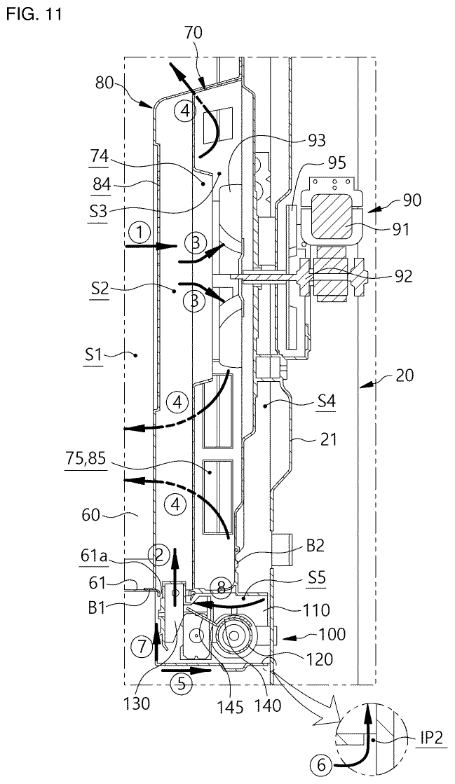

The circulation device C and the heating device 100 may be connected to each other via a connection passage 61a (referring to FIG. 11) provided in the frame 60. In this embodiment, the connection passage 61a is formed through the frame lower surface 61. The circulation device C may be arranged above the connection passage 61a, and the heating device 100 may be arranged below the connection passage 61a. The connection passage 61a may be provided at a rear portion of the frame lower surface 61, which is close to the frame rear surface 65. As another example, the connection passage 61a may be provided at either side portion of the frame lower surface 61, which is close to the frame side surface 62. As another example, the connection passage 61a may be provided in the frame side surface 62. In this case, the heating device 100 may be arranged at a position opposite to the circulation device C with the frame side surface 62 located therebetween.

The circulation device C may be arranged inside of the cooking chamber S1. In this embodiment, the circulation device C is arranged in front of the rear panel 20. The circulation device C may be at the rear side of the cooking chamber S1 and suction air from the front side of the cooking chamber S1 rearward (referring to X-axial direction in FIG. 1), and then discharge the air sideways. The circulation device C may include the circulation fan 93 to provide suction and discharge functions. However, as described hereinafter, in this embodiment, the heating device 100 may cause heated air to rise by natural draft. Therefore, even when the circulation fan 93 does not operate, heated air may be supplied to the cooking chamber S1.

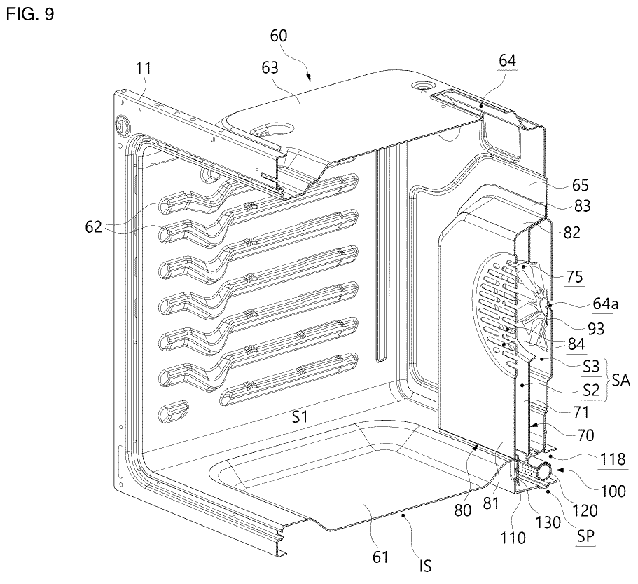

Referring to FIG. 9, a circulation chamber SA may be provided inside of the circulation device C. The circulation chamber SA may be connected to the cooking chamber S1. In the circulation chamber SA, air introduced from the cooking chamber S1 may exchange heat with air heated by the heating device 100. The heat-exchanged air may be discharged back to the cooking chamber S1.

The circulation chamber SA may form an upper flow path connected to the cooking chamber S1. The upper flow path may be a path through which air is suctioned from the cooking chamber S1 and discharged back to the cooking chamber S1. The combustion chamber S5 inside of the heating device 100, which will be described hereinafter, may form a lower flow path that transfers air heated by the burner 120 to the upper flow path. The upper flow path and the lower flow path may be connected to each other in a heightwise direction of the frame 60 via the connection passage 61a formed in the frame lower surface 61. The heightwise direction of the frame 60 is a vertical direction based on the drawing and is a Z-axial direction in FIG. 1. This flow path structure will be described hereinafter.

The circulation device C may include the partition plate 70 and the cover plate 80. The cover plate 80 may be arranged in front of the rear panel 20. The partition plate 70 may be arranged between the cover plate 80 and the rear panel 20. The partition plate 70 and the cover plate 80 may have similar shapes, and a size of the cover plate 80 may be larger than a size of the partition plate 70. The cover plate 80 may be coupled to the frame rear surface 65 while covering and shielding the partition plate 70.

The partition plate 70 may be made of a metal material, and a partition body 71 may form a frame of the partition plate 70. The partition body 71 may have a roughly flat structure. A partition bending part or portion 72 may be provided at an edge of the partition body 71. The partition plate 70 may have a frontward-rearward directional thickness by the partition bending portion 72. A partition coupling end 73 provided at an end of the partition bending portion 72 may be coupled to the frame rear surface 65 while overlapping with a cover coupling end 83 of the cover plate 80.

A communication hole 74 may be open in the partition body 71. The communication hole 74 may be formed through the partition body 71 in a frontward-rearward direction. The communication hole 74 may have a roughly circular structure. The communication hole 74 may be connected to the suction hole 84 of the cover plate 80. The communication hole 74 may be provided at a position corresponding to a position behind the suction hole 84. The circulation fan 93 may be arranged in the communication hole 74, so the communication hole 74 may be considered a fan installation space.

Multiple first discharge holes 75 may be formed in the partition bending portion 72. The first discharge holes 75 may be formed through the partition bending portion 72. The first discharge holes 75 may be open in directions different from an open direction of the communication hole 74. In this embodiment, the first discharge holes 75 may be open sideways. The first discharge holes 75 may be connected to the second discharge holes 85 of the cover plate 80. The air heated by the heating device 100 may be supplied into the cooking chamber S1 via the first discharge holes 75 and the second discharge holes 85.

The partition plate 70 may partition a space between the cover plate 80 and the frame rear surface 65. The circulation chamber SA may be provided between the partition plate 70 and the frame rear surface 65. The circulation chamber SA may be divided into two parts or portions by the partition plate 70. More specifically, as illustrated in FIG. 9, the circulation chamber SA may be divided into a front heating chamber S2 closer to the cooking chamber S1 on the basis of the partition plate 70, and a rear discharge chamber S3. The heating chamber S2 may be a space in which air heated by the heating device 100 and air suctioned from the cooking chamber S1 are mixed together. The discharge chamber S3 may be a space in which the air mixed in the heating chamber S2 is discharged back to the cooking chamber S1. Of course, a part or portion of the air in the cooking chamber S1 may flow directly into the discharge chamber S3. However, when the circulation fan 93 is operated, most of the air in the discharge chamber S3 may be discharged to the cooking chamber S1.

The cover plate 80 may be made of a metal material, and a cover body 81 may form a frame of the cover plate 80. The cover body 81 may have a roughly flat structure. A cover bent part or portion 82 may be provided at an edge of the cover body 81. The cover plate 80 may have a frontward-rearward directional thickness by the cover bent portion 82. The cover coupling end 83 provided at the end of the cover bent portion 82 may be coupled to the frame rear surface 65 while overlapping with the partition coupling end 73 of the partition plate 70.

A lower end of the cover plate 80 and a lower end of the partition plate 70 may be respectively supported by the frame 60. The structure in which the lower end of the cover plate 80 and the lower end of the partition plate 70 are supported by the frame 60 will be described hereinafter with a structure in which the heating device 100 is supported by the frame 60.

The cover plate 80 may be coupled to the frame rear surface 65 while covering the partition plate 70, so the partition plate 70 may be shielded by the cover plate 80. As illustrated in FIG. 3, when the cooking chamber S1 is viewed from the front, only the cover plate 80 is exposed.

The suction hole 84 may be open in the cover body 81. The suction hole 84 may be formed through the cover body 81 in the frontward-rearward direction. The suction hole 84 may be a hole for suctioning air in the cooking chamber S1. The air suctioned through the suction hole 84 may flow into the heating chamber S2. In this embodiment, the suction hole 84 has a roughly circular structure. The suction hole 84 may have a louver form, and an inside part or portion of the suction hole 84, that is, most of the structure of the partition plate 70 may be shielded. As another example, the suction hole 84 may have a simple circular hole as with the communication hole 74 or may have different forms other than a circular form.

The suction hole 84 may be connected to the communication hole 74 of the partition plate 70. The suction hole 84 may be provided at a position corresponding to a position in front of the communication hole 74. The circulation fan 93 may be arranged behind the suction hole 84, and air may be suctioned through the suction hole 84.

The cover bent portion 82 may include the multiple second discharge holes 85. The second discharge holes 85 may be formed through the cover bent portion 82. Each of the second discharge holes 85 may be open in directions different from a direction in which the suction hole 84 is open. In this embodiment, the second discharge holes 85 are open sideways. The second discharge holes 85 may be connected to the first discharge holes 75 of the partition plate 70. The air heated by the heating device 100 may be supplied into the cooking chamber S1 via the first discharge holes 75 and the second discharge holes 85.

In this embodiment, the first discharge holes 75 and the second discharge holes 85 may be respectively provided in side surfaces and inclined surfaces of the partition bending portion 72 and the cover bent portion 82. As another example, the first discharge holes 75 and the second discharge holes 85 may be respectively provided in upper surfaces and lower surfaces of the partition bending portion 72 and the cover bent portion 82.

FIG. 8 illustrates the cover plate 80 in which a part or portion is cut off. The circulation fan 93 may be provided inside of the cover plate 80. When the circulation fan 93 is operated, external air may be induced toward the heating device 100 (direction of arrow \textcircled{1}. The heated air passing through the heating device 100 may flow upward toward the circulation device C (direction of arrow \textcircled{2}). Due to a suction force of the circulation fan 93, air transferred toward the circulation fan 93 (direction of arrow \textcircled{3} may be discharged outward by rotation of the circulation fan 93 (direction of arrow \textcircled{4}), that is, discharged into the cooking chamber S1.

As described above, in this embodiment, the heating device 100 may be arranged at a lower portion of the circulation device C. Air heated by the heating device 100 may (i) be caused to rise by or flow upward due to the suction force of the circulation fan 93, and (ii) may be caused to rise or flow upward by natural draft. In other words, when a temperature of air is increased by the heating device 100, a volume of the air expands, a density is lowered, and a buoyant force increases, so the air rises or flows upward. Specific structure related to the circulation of air will be described hereinafter.

The circulation fan 93 may be coupled to a fan motor 91 to form a fan assembly 90. The fan assembly 90 may include the fan motor 91, the circulation fan 93, a rotational shaft 92, and a motor cooling fan 95. The fan motor 91 and the motor cooling fan 95 may be arranged outside of the outer case 10. More specifically, the fan motor 91 and the motor cooling fan 95 may be arranged on a rear surface of the rear panel 20 forming the outer case 10. Referring to FIG. 5, the fan motor 91 arranged at the rear panel 20 and exposed rearward is illustrated.

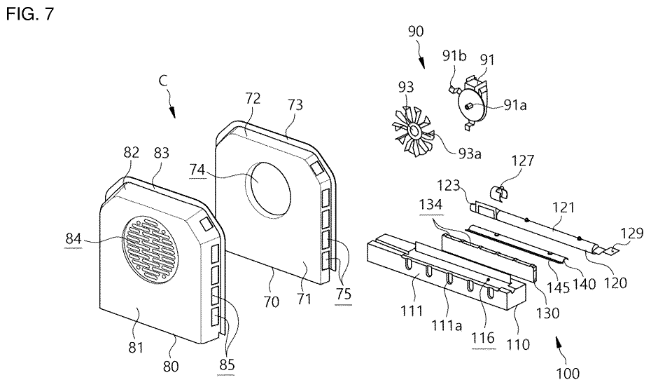

As illustrated in FIG. 7, the fan motor 91 may include a motor central part or portion 91a at a central portion thereof, and the rotational shaft 92 may be coupled to the motor central portion 91a. The fan motor 91 includes a fan bracket 91b, and the fan bracket 91b may be fixed to the rear panel 20. The motor cooling fan 95 may be rotated coaxially with the circulation fan 93 by the rotational shaft 92. The motor cooling fan 95 may cool the fan motor 91. As another example, the motor cooling fan 95 may be omitted.

As illustrated in FIG. 8, the circulation fan 93 may be arranged in front of the frame rear surface 65. The circulation fan 93 may be arranged opposite to the motor cooling fan 95 and the fan motor 91, with the frame rear surface 65 and the rear panel 20 located therebetween. The rotational shaft 92 may pass through a panel through hole 24 of the rear panel 20 and a shaft through hole (not illustrated) of the frame rear surface 65, and then connect the circulation fan 93 to the fan motor 91.

As illustrated in FIG. 9, in this embodiment, the circulation fan 93 may be arranged inside of the circulation chamber SA. The circulation fan 93 may be considered a part or portion of the circulation device C. Further, an entire part or portion of the fan assembly 90 may be considered a part or portion of the circulation device C. As another example, the fan assembly 90 may not be arranged at the rear panel 20 and may be arranged at the side panel 12 or the upper panel. As another example, the fan assembly 90 may be omitted.

The heating device 100 may be configured to heat air. The heating device 100 may be configured (i) to heat air introduced from the outside space, and (ii) to heat air inside of the cooking chamber S1. In this embodiment, the heating device 100 may be arranged outside of the cooking chamber S1, and mostly air introduced from the outside space is heated. However, when a portion of the internal air of the cooking chamber S1 flows into the heating device 100, the heating device 100 may heat the internal air.

The heating device 100 may be arranged outside of the frame 60. In this embodiment, the heating device 100 may be arranged below the frame lower surface 61. Referring to FIG. 10, the heating device 100 may be arranged between the frame lower surface 61 and the lower panel 17. More specifically, the heating device 100 may extend in one direction along a rear edge of the lower portion of the frame 60.

Referring to FIG. 10, an installation space IS may be provided between the frame lower surface 61 and the lower panel 17. The heating device 100 may be arranged inside of the installation space IS. The heating device 100 may be arranged at a rear portion of the installation space IS, that is, at a position close to the rear panel 20.

As described above, when the heating device 100 is arranged outside of the frame 60, intrusion of the heating device 100 into the cooking chamber S1 is prevented. Therefore, the space in the cooking chamber S1 is not reduced due to the heating device 100 and may be widened. More specifically, in this embodiment, a heating component, such as the burner 120, is omitted in the circulation device C, and a component, such as a burner reflector for assisting a heating component, is omitted. Therefore, a rear space of the cooking chamber S1 may be widened.

The installation space IS is an empty space. Therefore, even when the heating device 100 is arranged therein, an entire size of the cooking appliance is prevented from increasing. Further, the installation space IS may be an external air introduction part or portion into which external air is introduced. Accordingly, air introduced through the installation space IS may cool a lower surface of the heating device 100 during the introduction process. This structure will be described hereinafter.

Referring to FIG. 10, the burner 120 provided at the heating device 100 may generate a flame in a forward direction, that is, generate a flame in a direction toward the door 50 (direction of arrow \textcircled{1}). Herein, a direction in which the burner 120 generates the flame may be a first direction. In addition, the circulation device C and the heating device 100 may be arranged in a second direction (direction of arrow \textcircled{2}) different from the first direction. Therefore, the flame produced by the heating device 100 may heat air in a front space in the heating device 100 (the combustion chamber S5, referring to FIG. 18), and the heated air may move upward to the heating chamber S2. In this embodiment, the first direction and the second direction may be formed to be orthogonal to each other. As another example, the first direction may be a direction inclined upward from the horizontal direction.

Referring to FIG. 11, an air flow caused by the circulation device C and the heating device 100 may be indicated by arrows. First, in the air flow caused by the circulation device C, when the circulation fan 93 is operated, the air in the cooking chamber S1 may be suctioned in a direction toward the circulation fan 93 (direction of arrow \textcircled{1}).

At the same time, air in the combustion chamber S5 heated by the heating device 100 is caused to rise or flows upward in the direction of the heating chamber S2 of the circulation device C (direction of arrow \textcircled{2}). The heated air caused to rise or flowing upward to the heating chamber S2 may be mixed with the air that is suctioned from the cooking chamber S1. At this point, a temperature of the air suctioned from the cooking chamber S1 is relatively low, and a temperature of the air caused to rise or flowing upward from the heating device 100 is relatively high as the air is heated. When the two types of air are mixed and exchange heat with each other, the temperature of the mixed air may be higher than the temperature of the air introduced from the cooking chamber S1.

As described above, the air heated by the heating device 100 may rise or flow upward due to natural draft in the direction toward the heating chamber S2 of the circulation device C (direction of arrow \textcircled{2}). Therefore, even when the circulation fan 93 is not operated, the heated air may be supplied to the cooking chamber S1.

The mixed air passes through the communication hole 74 of the partition plate 70 and moves to the discharge chamber S3 (direction of arrow \textcircled{3}). The air entering the discharge chamber S3 may be discharged back to the cooking chamber S1 through the first discharge holes 75 and the second discharge holes 85 connected to each other (direction of arrow \textcircled{4}). At this point, the discharge of the mixed air into the cooking chamber S1 may be achieved by operation of the circulation fan 93 but may be achieved by a pressure difference due to the air raised from the combustion chamber S5 by natural draft.

When the burner 120 is operated to heat the air of the combustion chamber S5, the heating device 100 may be overheated. Further, the frame 60 arranged at an upper portion of the heating device 100 may be deformed by high temperature heat or an enamel coating layer of the frame 60 may be damaged. To prevent the above problem, in this embodiment, the heating device 100 and the frame 60 may be cooled using external air.

Referring to FIG. 11, external air passing through a lower part or portion of the heating device 100 may be indicated by arrow \textcircled{5}. The external air may move along a lower surface of the heating device 100. The external air may be a secondary air supplied to the burner 120 and may perform a cooling function.

The external air cooling the lower surface of the heating device 100 while passing through the lower surface of the heating device 100 may be introduced into the heating device 100 (direction of arrow \textcircled{6}). More specifically, as illustrated in the enlarged view of FIG. 11, air may be introduced into the heating device 100 through a second inlet IP2, that is, a gap formed between the heating device 100 and the rear panel 20.

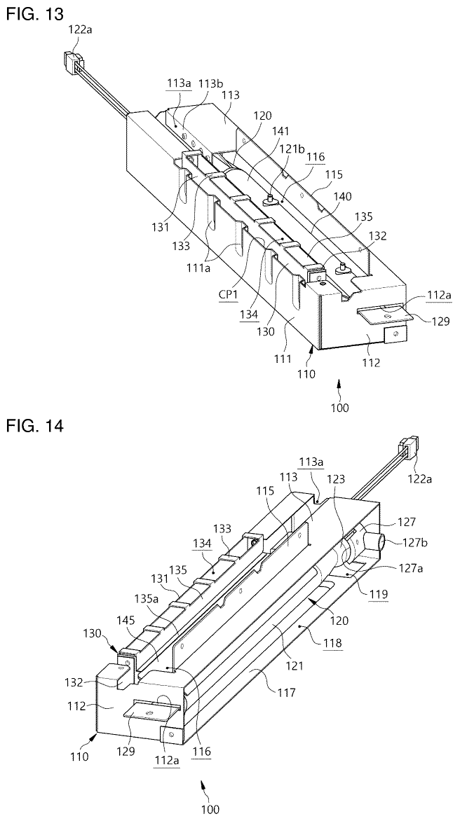

Some of the air may be heated by the heating device 100 to move to the heating chamber S2, and another part or portion may move along cooling flow path CP1, CP2 (referring to FIG. 18) partitioned by a flow path guide 130 of the heating device 100. More specifically, a part or portion of the air for cooling moves along a lower portion of the burner 120 inside of the heating device 100 and then rises or flows upward through a space (cooling flow path) CP1 formed by spacers 111a (referring to FIG. 13). In this process, the lower surface of the heating device 100, and a front surface of the heating device 100, and the lower portion of the frame 60 may be prevented from being overheated (referring to direction of arrow \textcircled{7}).

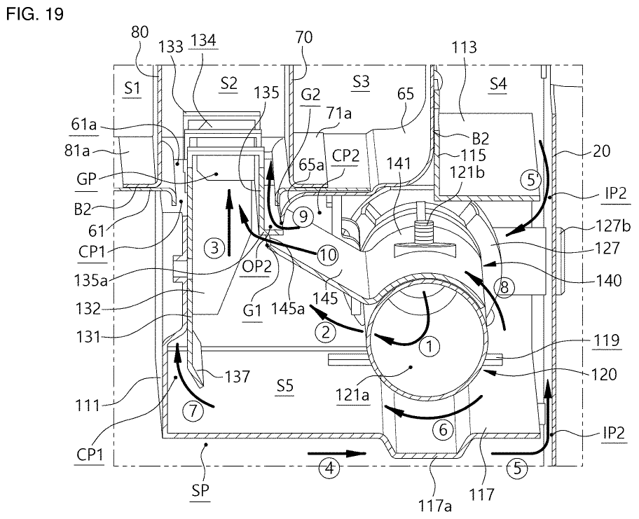

Another part or portion of the air for cooling may move along an upper portion of the burner 120 and may prevent overheating of the upper surface of the heating device 100, a flame guide 140, and the lower portion of the frame 60 (referring to direction of arrow \textcircled{8}). The air flowing into the upper portion of the cooking chamber S1 (arrow \textcircled{8}) may be introduced through another second inlet IP2 provided at the upper portion of the heating device 100 (referring to arrow \textcircled{5}′ of FIG. 19). This structure will be described hereinafter.

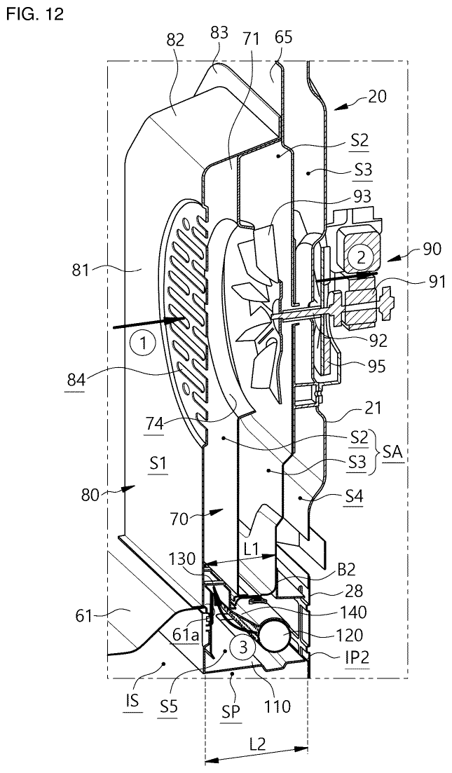

Referring to FIG. 12, the internal structure of the circulation device C and the heating device 100 is illustrated. Air suctioned through the suction hole 84 of the cover plate 80 may enter the heating chamber S2 (direction of arrow \textcircled{1}), and the heating chamber S2 may be filled with air heated by the heating device 100. Accordingly, the air of the cooking chamber S1 may be heated in the process in which the air moves toward the communication hole 74 while passing through the suction hole 84. The motor cooling fan 95 of the fan assembly 90 may rotate with the circulation fan 93, discharge air toward the fan motor 91 (direction of arrow \textcircled{2}), and cool the fan motor 91.

A flame generated by the burner 120 may heat air in the combustion chamber S5. A generation direction of the flame generated by the burner 120 may be guided by the flame guide 140, which will be described hereinafter. Arrow \textcircled{3} indicates a direction in which the flame is guided by the flame guide 140. The flame may be naturally directed to the heating chamber S2. More specifically, the air in the combustion chamber S5 heated by the heat of combustion may pass through a flow path formed by the flame guide 140 and the flow path guide 130, which will be described hereinafter. In addition, the air rising or flowing upward along the flow path may pass through the connection passage 61a provided on the frame lower surface 61 and move to the heating chamber S2.

In this embodiment, a frontward-rearward length L2 of the heating device 100 is longer than a frontward-rearward length L1 of the lower portion of the circulation device C. The frontward-rearward direction is a direction from the door 50 toward the frame rear surface 65. In other words, the frontward-rearward direction is a direction in which the cover plate 80 and the partition plate 70 are coupled to each other, and may be considered a shaft direction of the rotational shaft 92.

When the frontward-rearward length of the heating device 100 is longer than the frontward-rearward length of the lower portion of the circulation device C, an upper area of the circulation device C may be entirely included in an upper area of the heating device 100. As illustrated in FIG. 12, an entire lower portion of the circulation device C may be overlapped with the upper portion of the heating device 100. Accordingly, the frontward-rearward length of the circulation device C and the heating device 100 may be the frontward-rearward length of the heating device 100. Therefore, in the cooking appliance, the frontward-rearward length occupied by the circulation device C and the heating device 100 may be minimized.

Further, when the entire lower portion of the circulation device C overlaps with the upper portion of the heating device 100, a transfer path between the combustion chamber S5 and the circulation chamber SA may be minimized. When the transfer path between the combustion chamber S5 and the circulation chamber SA is shortened, heat loss may be reduced, and an efficiency of the cooking appliance may increase. In addition, the discharge chamber S3 may be arranged to overlap with the combustion chamber S5, so heat of the combustion chamber S5 may be conducted to the discharge chamber S3. The conducted heat heats air in the discharge chamber S3 to increase heat efficiency of the cooking appliance.

In this embodiment, the upper portion of the heating device 100 overlaps with the lower portion of the circulation device C, and may not overlap with the bottom of the cooking chamber S1. This prevents heat in the heating device 100 from directly heating the bottom surface of the cooking chamber S1 and simultaneously enables heat of the heating device 100 to be focused on the circulation device C.

Referring to FIG. 11, based on an extension direction of a flow path in which the combustion chamber S5 and the heating chamber S2 are connected to each other, the burner 120 may be arranged in a position that deviates from a range in which the burner overlaps with the heating chamber S2. The extension direction of the flow path may be the vertical direction, that is, a direction in which the circulation device C and the heating device 100 are stacked. Based on the extension direction of the flow path, the burner 120 may be arranged to be biased rearward, that is, toward the rear panel 20, thereby preventing the burner 120 and the heating chamber S2 from overlapping with each other.

Based on the extension direction of the flow path in which the combustion chamber S5 and the heating chamber S2 are connected to each other, the entire part or a part or portion of the burner 120 may be arranged at a position at which the burner 120 overlaps with the discharge chamber S3. As illustrated in FIG. 11, a part or portion of the burner 120 may be arranged to overlap with the discharge chamber S3 vertically.

In this embodiment, the heating device 100 may protrude rearward, that is, toward the rear panel 20, more than the circulation device C. Referring to FIGS. 11 and 12, the heating device 100 may protrude to a position adjacent to a surface of the rear panel 20, but the circulation device C may be relatively spaced apart forwardly from the surface of the rear panel 20 (the left side based on the drawing). As described above, an extension part or portion (not given reference numeral) where the heating device 100 further protrudes than the circulation device C may be used as an inflow space to introduce external air into the heating device 100. Through an upper portion and a lower portion of the extension portion where the heating device 100 protrudes further than the circulation device C, external air may be efficiently introduced into the combustion chamber S5. As described hereinafter, a portion where the heating device 100 and the rear panel 20 face each other may be formed at a predetermined distance to form an introduction path, and external air may be introduced into the combustion chamber S5 through the introduction path.

Referring to FIGS. 13 to 17, the heating device 100 will be described. The heating device 100 may include the combustion chamber S5 therein, and the combustion chamber S5 may include the burner 120. The burner 120 may generate a flame using gas and heat air in the combustion chamber S5. The heating device 100 may heat air in the combustion chamber S5 and transfer the heated air to the heating chamber S2.

The combustion chamber S5 may form the lower flow path through which air heated by the burner 120 flows to the upper flow path. The upper flow path may be considered an air transfer path inside of the circulation chamber SA. In this embodiment, the upper flow path and the lower flow path may be connected to each other in a heightwise direction of the frame 60 through the connection passage 61a provided in the frame lower surface 61.

The burner case 110 may form a frame of the heating device 100. The burner case 110 may have a roughly hexahedral structure. The burner case 110 may be made of a metal material having high heat-resistance, for example. A part or portion of an upper surface and a rear surface of the burner case 110 may be open. The open portion of the upper surface of the burner case 110 may be covered by the frame lower surface 61. The open rear surface of the burner case 110 has the chamber opening 118, and the chamber opening 118 may be covered by the shielding cover 28 described above. This structure will be described hereinafter.

The burner case 110 may include a front plate 111 forming a front surface of the combustion chamber S5. The burner case 110 may include side plates 112 that form side surfaces of the combustion chamber S5. The burner case 110 may include an upper plate 113 that provides an upper surface of the combustion chamber S5. The burner case 110 may include lower plate 117 that forms a bottom surface of the combustion chamber S5. The front plate 111, the side plates 112, the upper plate 113, and the lower plate 117 may be formed by bending one metal sheet. As another example, the burner case 110 may be formed of multiple components that are coupled to each other using a method, such as welding or assembled with each other by a fastener, such as a screw.

The front plate 111 may include the spacer 111a. The spacer 111a may be formed of a part or portion of the front plate 111 that protrudes into the combustion chamber S5. The spacer 111a may form an uneven structure on a section of the front plate 111. In this embodiment, the multiple spacers 111a may be arranged in a longitudinal direction of the front plate 111, that is, at intervals in an extension direction of the burner 120.

The spacer 111a may be in close contact with a guide front surface 131 of the flow path guide 130 arranged in the combustion chamber S5. A gap between one spacer 111a and another spacer 111a adjacent thereto is spaced apart from the guide front surface 131 to form a passage. The passage may be cooling flow path CP1. When some of the external air introduced into the combustion chamber S5 which is not heated by the burner 120 or air at the bottom side of the combustion chamber S5 which is less affected by the burner 120 rises or flows upward through the cooling flow path CP1, the air may cool not only the front plate 111 and a surface of the flow path guide 130 but also the frame lower surface 61. The cooling flow path CP1 may be referred to as first cooling flow path CP1 to distinguish it from cooling flow path CP2, which is a different path described hereinafter.

The spacer 111a may extend to an upper end of the front plate 111 and may be provided only to the upper portion rather than a lower end of the front plate 111. Referring to a path indicated by arrow \textcircled{7} of FIG. 19, a continuous path may be formed from a portion where a front portion of the lower plate 117 and a lower portion of the front plate 111 without the spacer 111a are connected to each other, to the first cooling flow path CP1 provided between a surface of the guide front surface 131 and a rear surface of the front plate 111. External air may pass through the path. As another example, the spacer 111a may protrude from the guide front surface 131 toward the front plate 111, rather than the front plate 111.

As described above, a portion of the cooling flow path CP1, CP2 may be formed in a heightwise direction of the combustion chamber S5 between the surface of the burner case 110 and the surface of the flow path guide 130 facing each other.

Referring to FIG. 13, each side plate 112 may include a bracket hole 112a through which a bracket 129 of the burner 120 may pass. The bracket 129 passing through the bracket hole 112a may be fixed to the frame 60. For reference, in this embodiment, the burner 120 may remain fixed by the bracket 129 and a burner fixation piece 128 of the burner 120, which will be described hereinafter.

The upper plate 113 may include an interference avoidance part or portion 113a. The interference avoidance portion 113a may be formed such that a part or portion of the upper plate 113 is omitted to expose the combustion chamber S5. The interference avoidance portion 113a may be provided to prevent interference with structure (not illustrated) that protrudes from a lower portion of the frame 60.

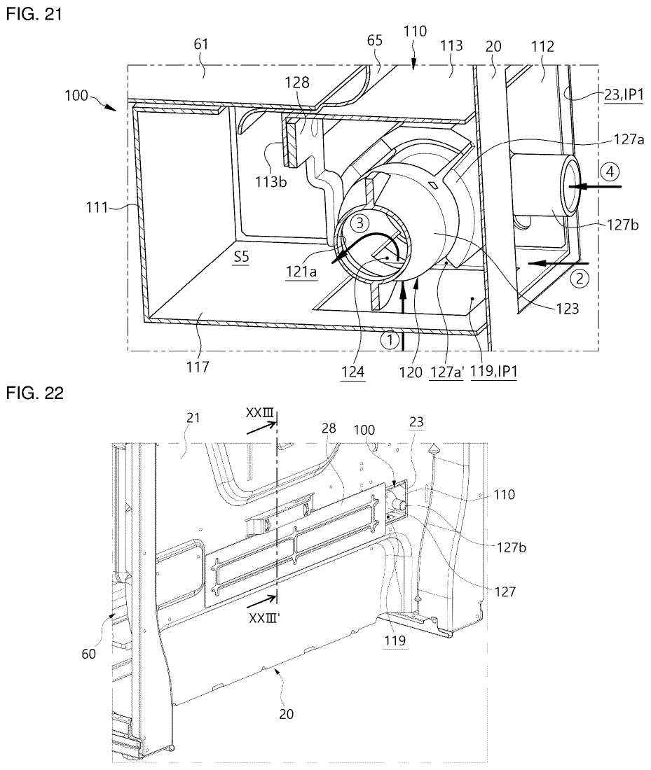

To form the interference avoidance portion 113a, a part or portion of the upper plate 113 may be cut and then bent downward. The bent portion may be a fixation rib 113b. Referring to FIG. 21, the burner fixation piece 128 provided at the burner 120 may be coupled to the fixation rib 113b. Eventually, one end portion of the burner 120 may be supported by the fixation rib 113b.

The upper plate 113 may include an upper opening 116 at a portion adjacent to the interference avoidance portion 113a. The upper opening 116 may have a form in which a part or portion of the upper plate 113 is vertically open. The upper opening 116 may be formed in a long shape that extends lengthwise in the extension direction of the burner 120. The upper opening 116 may be formed of a portion of the upper plate 113 cut and then bent upward.

The upper opening 116 may be covered with the frame rear surface 65. Referring to FIG. 19, a portion bent forward from a lower end of the frame rear surface 65 may cover the upper opening 116. The portion bent forward from the lower end of the frame rear surface 65 may overlap with an upper portion of the frame lower surface 61. The end of the frame rear surface 65 may be bent downward to form a flow path entrance end 65a. A structure of the flow path entrance end 65a will be described hereinafter.

A part or portion of the upper plate 113 may be bent to form a case supporter 115. As the case supporter 115 is bent, a space formed thereby may be the upper opening 116. The case supporter 115 may fix the heating device 100 to the frame 60. As the case supporter 115 is coupled to the frame 60, the heating device 100 may be supported by the frame 60. Referring to FIGS. 10 and 18, the case supporter 115 in close contact with the frame rear surface 65 is illustrated. In this state, a fastener, such as a screw (not illustrated), may fix the case supporter 115 to the frame 60. Reference numeral B2 is a second coupling part or portion where the case supporter 115 is coupled to the frame rear surface 65. As described above, in this embodiment, the heating device 100 may be supported by being coupled to the frame 60.

More specifically, the heating device 100 may be coupled to a first surface among surfaces of the frame rear surface 65, the first surface facing the rear panel 20. On the other hand, the circulation device C may be fixed to a second surface among surfaces of the frame rear surface 65, the second surface facing the cooking chamber S1. As described above, the circulation device C may be fixed to a first surface among wall surfaces of the frame 60, the first surface facing the cooking chamber S1, to provide a first coupling part or portion B1. The heating device 100 may be fixed to a second surface of the frame 60 opposite to the first surface to provide the second coupling portion B2.

More specifically, as described above, in this embodiment, the circulation device C may also be fixed to the frame 60. The cover coupling end 83 provided at the end of the cover bent portion 82 may be coupled to the frame rear surface 65 while overlapping with the partition coupling end 73 of the partition plate 70. The lower end portion of the partition plate 70 and the lower end portion of the cover plate 80 may be supported by the frame 60. Referring to FIG. 18, a lower end bent portion 71a of the partition plate 70 may be in close contact with an upper portion of the frame rear surface 65 to provide the first coupling portion B1 (referring to FIG. 19). Further, a lower end bent portion 81a of the cover plate 80 may be in close contact with the frame lower surface 61 to provide the first coupling portion B1.

As described above, the heating device 100 and the circulation device C may be coupled to the frame 60 to be supported thereby. The circulation device C and the heating device 100 may be fixed to the surfaces of the frame 60 at different positions. The heating device 100 may be supported by the frame 60, so the heating device 100 may not depend on the circulation device C for mounting thereof. Accordingly, the heating device 100 may not be in direct contact with the circulation device C. In other words, while the surface of the circulation device C and the surface of the heating device 100 are in non-contact with each other, the heating device 100 may be fixed to the frame 60. Accordingly, an amount of radiant heat generated from the surface of the heating device 100 which is transferred to the circulation device C is reduced, and a flame of the burner 120 may be focused to heat air in the combustion chamber S5.

Referring to FIG. 14, the rear surface of the burner case 110 is open, and the chamber opening 118 may be formed thereby. The chamber opening 118 may be shaped in a roughly rectangle around edges of the upper plate 113, the lower plate 117, and the side plates 112. The chamber opening 118 may be open toward the rear panel 20. The chamber opening 118 may be connected to the panel opening 23 of the rear panel 20 but may be covered by the shielding cover 28.

Referring to FIG. 19, the lower plate 117 may include an uneven part or portion 117a. In this embodiment, the uneven portion 117a is arranged at a lower portion of the burner 120. The uneven portion 117a may be formed into a shape in which a part or portion of the lower plate 117 is bent. The uneven portion 117a increases a strength of the lower plate 117 to prevent the lower plate 117 from being deformed due to a high temperature of the combustion chamber S5.

The uneven portion 117a may expand a contact area between the burner case and external air passing through the lower portion of the burner case 110. The external air passing through the burner case 110 performs heat exchange by being brought into contact with the uneven portion 117a, and in this process, the lower plate 117 and the burner case 110 may be cooled. The external air is naturally introduced into the combustion chamber S5 which at a relatively low pressure, and the external air may pass through the lower plate 117 in this state.

An air inlet passage SP may be formed below the lower plate 117. The air inlet passage SP may be formed between the frame lower surface 61 and the drawer cover 47 or the frame lower surface 61 and the lower panel 17. The air inlet passage SP is a kind of space and may be considered a part or portion of the installation space IS. The air inlet passage SP may be a path through which external air is induced into the heating device 100.

In FIG. 19, arrow \textcircled{4} indicates a flow direction of external air that passes through the uneven portion 117a and cools the lower plate 117. The external air may pass through the air inlet passage SP and be brought into contact with the lower plate 117. As described above, the air cooling the lower plate 117 may move continuously along the air inlet passage SP, and may enter the combustion chamber S5 through the second inlet IP2, that is, a gap between the burner case 110 and the rear panel 20. This structure will be described hereinafter.

The frame lower surface 61 may include a combustion air hole 119. The combustion air hole 119 may be formed vertically through the frame lower surface 61. The combustion air hole 119 may be connected to a holder air hole 127a′ of the nozzle holder 127, which will be described hereinafter. Air introduced through the combustion air hole 119 may be supplied to the nozzle through the holder air hole 127a′ and may be used in a primary combustion of gas. Therefore, the combustion air hole 119 may constitute a first inlet.

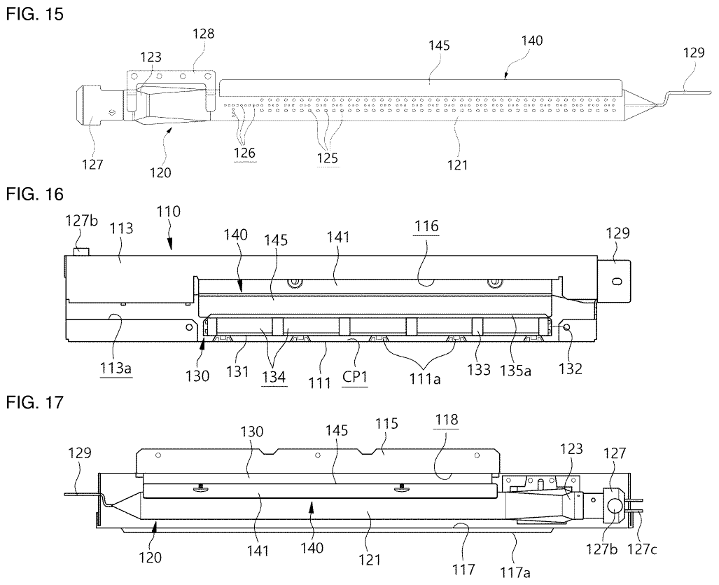

Next, referring to FIG. 15, the burner 120 of the heating device 100 will be described. For reference, FIG. 15 illustrates the flame guide 140 described hereinafter coupled to the burner 120. As described above, the burner 120 may be a linear pipe that extends in one direction along a rear edge of the lower portion of the frame 60. A burner body 121 forming a frame of the burner 120 may be shaped as a bar that extends in one direction. The burner body 121 may extend along a longitudinal direction of the burner case 110. Inside of the burner body 121, a gas flow path 121a may extend in a frontward-rearward direction, and a mixed gas may be supplied thereinto.

The burner 120 may be arranged at a position deviating from a heating flow path GP. The heating flow path GP is a flow path of air generated by the flow path guide 130, which will be described hereinafter. The heating flow path GP may be considered a path that connects the combustion chamber S5 and the heating chamber S2 to each other. As described above, when the burner 120 is arranged at a position deviating from the heating flow path GP, a distance from the burner 120 to the heating flow path GP may be secured, and a space in which air heated by a flame exists may be sufficiently formed. The burner 120 may generate a flame toward the heating flow path GP.

Referring to FIG. 6, a spark plug 122 is connected to the burner 120. The spark plug 122 may enable the mixed gas to be burned. The spark plug 122 may include a connector 122a (referring to FIG. 13) configured to be connected to a power source. The connector 122a may be coupled to a power component inside of the outer case 10.

A mixing tube 123 may be provided at one side portion of the burner body 121. The mixing tube 123 may mix external air and gas from the nozzle holder 127. When the burner 120 is operated, gas is supplied from the nozzle holder 127 to one end portion of the burner 120. A structure in which a width of the mixing tube 123 is reduced causes a lower pressure, and a pressure difference enables surrounding air to be naturally supplied toward the mixing tube 123. In addition, when the mixed gas is burned by the spark plug 122, a flame may be generated from a flame hole 125.

Referring to FIG. 21, a tube air hole 124 may be open in a lower portion of the mixing tube 123. The tube air hole 124 may be open toward the lower plate 117. The tube air hole 124 may be connected to the holder air hole 127a′ of the nozzle holder 127 coupled to the mixing tube 123. Accordingly, external air may pass through the holder air hole 127a′ and the tube air hole 124 and then may be introduced into the gas flow path 121a of the burner body 121. For reference, the lower plate 117 may include the combustion air hole 119 open in a position facing the tube air hole 124. Through the combustion air hole 119, external air, more specifically, external air introduced into the installation space IS may be introduced. The combustion air hole 119 may form the first inlet IP1, which will be described hereinafter.

More specifically, when gas is supplied into the burner body 121, some of air required for combustion (hereinafter, referred to as “primary air”) is introduced with the gas, and mixed gas in which the gas and the air are mixed may be burned at the flame hole 125. In addition, at a periphery of the flame where combustion is performed, air is newly introduced toward the flame (hereinafter, referred to as “secondary air”), which causes complete combustion. As described above, only when the secondary air is supplied in a sufficient quantity in the combustion process, may complete combustion be achieved. Accordingly, an efficiency of the burner 120 may increase. A supply structure of the secondary air will be described hereinafter.

Referring to FIG. 15, the flame hole 125 may be formed through the burner body 121. The flame hole 125 forms a passage through which mixed air inside of the burner body 121 is discharged outside of the burner body 121. Multiple flame holes 125 may be arranged at a side portion of the burner body 121 at predetermined intervals along a longitudinal direction of the burner body 121. Accordingly, the burner body 121 may include multiple gas discharge passages along the longitudinal direction of the burner body 121. Reference numeral 126 is an auxiliary flame hole arranged in front of the flame hole 125 to transfer flame.

In this embodiment, the flame hole 125 is provided only in a front surface of the burner body 121. The front surface of the burner body 121 is a surface of the burner 120 facing the door 50. The flame hole 125 is not provided in an upper, lower, or rear surface of the burner 120, and is provided only in a surface facing forward. The flame hole 125 may face the flow path guide 130.

The flame hole 125 may be open toward the lower flow path. The lower flow path is a path through which air flows inside of the combustion chamber S5. In this embodiment, at least a part or portion of the lower flow path may be formed by the flow path guide 130. When the flame hole 125 faces the lower flow path, a flame generated from the flame hole 125 does not heat a surface of the burner case 110 but heats concentrically air in the combustion chamber S5. Therefore, the burner 120 may heat air in the combustion chamber S5 efficiently, and it is possible to prevent the burner case 110 from being overheated by radiant heat. Further, in other words, an open direction of the flame hole 125 of the burner 120 may be in parallel to the direction of the rotational shaft 92 of the circulation fan 93. Otherwise, the flame hole 125 of the burner 120 may be open toward a flow path through which the circulation chamber SA and the combustion chamber S5 are connected to each other.

The multiple flame hole 125 may produce multiple flames. The multiple flame holes 125 may be arranged in the longitudinal direction of the burner body 121. Further, the multiple flame holes 125 may be arranged along a circumferential direction of the burner body 121. In this embodiment, the burner 120 includes three flame hole arrays having different angles along the circumferential direction. The three flame hole arrays may provide stronger firepower as flames from the three flame hole arrays are combined together.

The nozzle holder 127 may be provided at one side of the burner body 121. The nozzle holder 127 may transfer externally-supplied gas to the burner body 121. The nozzle holder 127 may be connected to a nozzle (not illustrated) of an external gas pipe (not illustrated). The nozzle holder 127 may transfer gas supplied from the gas pipe to the gas flow path 121a, and air and gas may be mixed in this process.

Referring to FIG. 21, a holder main body 127a of the nozzle holder 127 may be coupled to one end portion of the burner body 121 by covering the end portion. The holder air hole 127a′ may be formed in a lower portion of the holder main body 127a. The holder air hole 127a′ may be connected to the tube air hole 124 provided in the mixing tube 123. The holder air hole 127a′ may be connected to the tube air hole 124 to form one air suction passage. The air suction passage may be a path through which the primary air is supplied.

Referring to FIG. 21, the path through which the primary air at the external space is introduced is illustrated. The primary air may be introduced through the combustion air hole 119, that is, the first inlet IP1 formed in the lower plate 117, toward the inside space of the combustion chamber S5 (direction of arrow \textcircled{1}). In addition, the introduced primary air may pass through the holder air hole 127a′ and the tube air hole 124 successively, and then move along the gas flow path 121a of the burner body 121 (direction of arrow \textcircled{3}). The primary air may be introduced not only through the combustion air hole 119 but also through the panel opening 23 of the rear panel 20 (direction of arrow \textcircled{2}). The panel opening 23 is open toward the nozzle holder 127 so that the primary air may be efficiently supplied.

The combustion air hole 119 and the panel opening 23 may form the first inlet IP1. The first inlet IP1 may be a passage through which air is directly supplied to the gas flow path 121a of the burner body 121. Even when the panel opening 23 is shielded by the shielding cover 28, the nozzle holder 127 is open, so it may be a part or portion of the first inlet. As another example, one of the combustion air hole 119 or the panel opening 23 may be omitted, and only the remaining one may form the first inlet IP1.

A gas inlet hole 127b may be open in the nozzle holder 127. The gas inlet hole 127b may be connected to the gas pipe. In this embodiment, the gas inlet hole 127b may be open in a different direction from the holder air hole 127a′. More specifically, the gas inlet hole 127b may face the panel opening 23 of the rear panel 20. Accordingly, the gas inlet hole 127b may be exposed outward through the panel opening 23. In FIG. 21, arrow \textcircled{4} indicates a path through which external gas is supplied toward the gas inlet hole 127b.

Referring to FIG. 21, the burner fixation piece 128 coupled to the burner main body 121 may be in close contact with the fixation rib 113b. The burner body 121 may be fixed to the burner case 110 and the frame 60 by the burner fixation piece 128 and the bracket 129 at the opposite side.

The flow path guide 130 forming the heating device 100 will be described hereinafter. Referring to the exploded view of FIG. 7, the flow path guide 130 may be shaped in a roughly hexahedron shape. The flow path guide 130 may be stored in the combustion chamber S5, so that the flow path guide 130 may have a volume less than or equal to a volume of the combustion chamber S5. The flow path guide 130 may be formed as a separate component from the burner case 110 and then arranged at the combustion chamber S5. As another example, the flow path guide 130 may be integrated with the burner case 110.

The flow path guide 130 may form multiple flow paths with the burner case 110. The flow path guide 130 may partition the combustion chamber S5 into multiple spaces and generate respective air flows in the partitioned spaces. The term “partitioned” means that, even when two spaces are not completely separated from each other, air flows into each separate space. As described hereinafter, the flow path guide 130 may partition a connection passage 61a′ into a heating outlet 134 and a cooling outlet OP1, OP2.

The flow path guide 130 may partition the combustion chamber S5 into multiple flow paths. A part or portion GP of the flow paths may transfer high temperature air heated by the burner 120 to the circulation chamber SA, and the other part or portion CP1, CP2 may cool components while allowing relatively low temperature air to pass therethrough. The flow path through which high temperature air passes may be the heating flow path GP, and the flow path through which low temperature air passes may be the cooling flow path CP1, CP2. In other words, the heating flow path GP may be a guide flow path that guides heated high temperature air along the inside space of the flow path guide 130. The cooling flow path CP1, CP2 provided outside of the flow path guide 130 may be a cooling flow path through which relatively low temperature air introduced from the external space flows. The above-mentioned flow paths will be described hereinafter.

As described above, the flow path guide 130 may provide the heating flow path GP and the cooling flow path CP1, CP2 separated from each other, inside of the combustion chamber S5. The heating flow path GP may be a path through which air heated by the burner 120 flows. The cooling flow path CP1, CP2 may be a path arranged around the burner 120, and may be a path through which relatively lower temperature air than the air flowing through the heating flow path GP flows.

The cooling flow path CP1, CP2 may include first cooling flow path CP1 and second cooling flow path CP2. The first cooling flow path CP1 may be a path that passes through an upper portion of the burner 120. The second cooling flow path CP2 may be a path that passes through a lower portion of the burner 120 and connected with the circulation device C along a surface of the heating device 100. This structure will be described hereinafter.

High temperature air of the combustion chamber S5 heated by the burner 120 may be transferred to the circulation chamber SA. More specifically, the flow path guide 130 may be connected to the heating chamber S2 in the circulation chamber SA and transfer heated air to the heating chamber S2. The flow path guide 130 may form a lower flow path inside of the combustion chamber S5. The lower flow path may be connected to an upper flow path formed by the heating chamber S2. The lower flow path may be considered the heating flow path GP provided inside of the flow path guide 130.

The flow path guide 130 may be open upward and rearward. An upward direction means a direction toward the heating chamber S2. A rearward direction means a direction toward the burner 120. The flow path guide 130 may guide a flow of air between the burner 120 and the heating chamber S2 through the heating flow path GP open upward and downward.

Referring to FIGS. 13 and 14, the flow path guide 130 may be inserted through the upper opening 116 of the burner case 110. The burner case 110 may be arranged in the upper opening 116 and may form a flow path of air moving upward through the upper opening 116. The flow path guide 130 may be shaped in a roughly hexahedron shape. The flow path guide 130 may be coupled to the burner case 110.

More specifically, the flow path guide 130 may include the guide front surface 131, a guide side 132, a guide upper surface 133, and a guide rear surface 135. The guide front surface 131 may form a front surface of the flow path guide 130. The guide side 132 may form a side surface of the flow path guide 130. The guide upper surface 133 may form an upper surface of the flow path guide 130. The guide rear surface 135 may form a rear surface of the flow path guide 130.

The heating outlet 134 may be open in the guide upper surface 133. The heating outlet 134 may be formed vertically in the guide upper surface 133. The heating outlet 134 may connect the heating flow path GP formed in the flow path guide 130 to the heating chamber S2. Multiple heating outlets 134 may be arranged in a leftward-rightward direction of the flow path guide 130. As another example, the heating outlet 134 may be shaped into one continuous long hole.

The guide front surface 131 may be in close contact with the front plate 111 of the burner case 110. More specifically, the guide front surface 131 may be in close contact with the spacer 111a of the front plate 111. The guide front surface 131 may be coupled to the spacer 111a by a fastener, such as a screw (not illustrated), or welded thereto. In this embodiment, the flow path guide 130 may be coupled only to the spacer 111a, and a remaining part or portion thereof may be not coupled to the burner case 110.

Referring to FIGS. 18 to 20, a width of an upper end of the flow path guide 130 may be narrower than a width of the connection passage 61a. Accordingly, an outer surface of the flow path guide 130 and an inner surface of the connection passage 61a may be spaced apart from each other. The cooling outlet OP1, OP2 may be formed between the flow path guide 130 and the connection passage 61a, which are spaced apart from each other as described above. The cooling outlet OP1, OP2 may be formed without disconnection around a surface of the upper end of the flow path guide 130. As another example, the cooling outlet OP1, OP2 may be partitioned into outlet OP1 of the flow path CP1 formed between the guide front surface 131 of the flow path guide 130 and the connection passage 61a, and outlet OP2 of the flow path CP2 formed between the guide rear surface 135 and the connection passage 61a, and the two outlets may not be connected to each other.

The cooling flow path CP1, CP2 may be provided around the flow path guide 130. At least a part or portion of the cooling flow path CP1, CP2 may be formed along a space that surrounds the flow path guide 130. Then, the first cooling flow path CP1 and the second cooling flow path CP2 may serve an insulation function around the heating flow path GP. The cooling flow path CP1, CP2 may be provided at the outside space of the flow path guide 130 and the inside space of the burner case 110.

As described above, the flow path formed by the flow path guide 130 may be partitioned. In other words, (i) the heating flow path GP formed inside of the flow path guide 130 and transferring heated air to the heating chamber S2 and (ii) the cooling flow path CP1, CP2 formed around the heating flow path GP and through which air having relatively low temperature passes are partitioned from each other. In other words, the heating flow path GP and the cooling flow path CP1, CP2 may form two flow paths.

The cooling flow path CP1, CP2 may include the first cooling flow path CP1 and the second cooling flow path CP2. The first cooling flow path CP1 and the second cooling flow path CP2 may be provided at respective outside portions of the flow path guide 130. The first cooling flow path CP1 and the second cooling flow path CP2 may be arranged at opposite sides with the heating flow path GP located therebetween, and may form different air flow paths. The first cooling flow path CP1 and the second cooling flow path CP2 are the same with respect to (i) connection between the combustion chamber S5 and the heating chamber S2, and (ii) pass of relatively low temperature air by formation of each path partitioned from the heating flow path GP.

The first cooling flow path CP1 may surround an upper end portion of the flow path guide 130 with the second cooling flow path CP2. Accordingly, the heating flow path GP provided inside of the flow path guide 130 may be a path through which air heated at a high temperature flows, and the second cooling flow path CP2 surrounding the heating flow path GP may be a cooling path through relatively low temperature air passes. The cooling path surrounds the heating flow path GP, thereby forming a kind of insulation layer.

Referring to FIG. 18, the upper end portion of the flow path guide 130 protruding into the heating chamber S2 is illustrated. In this embodiment, a part or portion of the flow path guide 130 passes through the connection passage 61a and then extends into the heating chamber S2. The heating outlet 134 of the heating flow path GP may also be located inside of the heating chamber S2. Accordingly, heated air passing through the heating flow path GP is prevented from leaking out of the flow path guide 130 and may be precisely transferred into the heating chamber S2. As described above, a part or portion of the flow path guide 130 protruding into the heating chamber S2 may be a protrusion (reference numeral not given).

When the protrusion which is a part of the flow path guide 130 passes through the connection passage 61a and then enters the inside space of the heating chamber S2, the heating outlet 134, which is the outlet of the heating flow path GP and the cooling outlet OP1, OP2 which is the outlet of the cooling flow path CP1, CP2 have a height difference therebetween. More specifically, the heating outlet 134 may be formed higher than the cooling outlet OP1, OP2. This structure may prevent high temperature air that is discharged through the heating outlet 134, and relatively low temperature air that is discharged through the cooling outlet OP1, OP2 from being mixed in the connection passage 61a. Therefore, high temperature air passing through the heating flow path GP may efficiently heat air inside of the heating chamber S2, and low temperature air passing through the cooling flow path CP1, CP2 may cool components around the connection passage 61a. More specifically, the lower portion of the frame 60 forming the surrounding portion of the connection passage 61a may be prevented from being deformed due to high temperature heat, or the enamel coating layer of the frame 60 may be prevented from being damaged.

Referring to FIG. 13, when the guide front surface 131 is in close contact with the spacer 111a, a vertically extending space may be formed between the front plate 111, the spacers 111a, and a surface of the guide front surface 131. This space may form the first cooling flow path CP1. When external air is not heated by the burner 120 or air at a bottom side of the combustion chamber S5 which is less affected by the burner 120 is raised through the first cooling flow path CP1, the first cooling flow path CP1 may cool not only the front plate 111 and a surface of the guide front surface 131 but also the frame lower surface 61. For reference, a path formed along the lower plate 117, the lower portion of the burner 120, may also be considered a part or portion of the first cooling flow path CP1.

Referring to the plan view of FIG. 16, the first cooling flow path CP1 formed between the two spacers 111a is illustrated. The first cooling flow path CP1 may provide a continuous path between the spacers 111a. A lower end of the first cooling flow path CP1 may be open toward the lower plate 117 of the burner case 110.

Referring to FIG. 18, an upper end of the first cooling flow path CP1 may be open toward the combustion chamber S5 between an upper portion of the flow path guide 130 and the connection passage 61a formed through the frame lower surface 61. More specifically, with the upper end portion of the flow path guide 130 arranged in the connection passage 61a, the first cooling outlet OP1 is formed between an outer surface of the flow path guide 130 and an inner surface of the connection passage 61a. In other words, the first cooling outlet OP1 may be formed around the upper end portion of the flow path guide 130.

Referring to FIG. 19, the second cooling flow path CP2 formed by the flow path guide 130 is illustrated. The second cooling flow path CP2 may be provided at the upper portion of the burner 120. The second cooling flow path CP2 may be formed between the flow path guide 130 and the frame lower surface 61. As described above, the second cooling flow path CP2 may be provided along an upper portion of the combustion chamber S5.

The second cooling flow path CP2 may be a flow path through which, in external air introduced into the combustion chamber S5, some of the air moving along the upper surface of the burner 120 passes. The air passing through the second cooling flow path CP2 may cool a surface of the flow path guide 130 and the frame lower surface 61. In FIG. 19, arrow \textcircled{9} indicates a flow path of air moving along the second cooling flow path CP2. As described hereinafter, the second cooling outlet OP2, that is, an outlet of the second cooling flow path CP2, may be continued between the guide rear surface 135 and the flow path entrance end 65a of the frame lower surface 61.

In this embodiment, the second cooling flow path CP2 may be formed parallel to the upper surface of the combustion chamber S5, that is, the upper plate 113 or the frame lower surface 61. Otherwise, the first cooling flow path CP1 is formed parallel to a surface of the combustion chamber S5, that is, the front plate 111. As described above, the first cooling flow path CP1 and the second cooling flow path CP2 may be formed in respectively different directions, or in respective areas. In this embodiment, a start path of the first cooling flow path CP1 is provided lower than the flame hole 125, and a start path of the second cooling flow path CP2 is provided higher than the flame hole 125.

The first cooling outlet OP1 and the second cooling outlet OP2, that is, the outlets of the cooling flow paths CP1 and CP2 may be formed between upper edges of the flow path guide 130 and the connection passage 61a provided in the frame lower surface 61. The first cooling outlet OP1 and the second cooling outlet OP2 may include structure that covers the heating outlet 134 of the heating flow path GP. Then, the first cooling outlet OP1 and the second cooling outlet OP2 may serve an insulation function around the heating outlet 134 of the heating flow path GP. For reference, each of the first cooling outlet OP1, the second cooling outlet OP2, and the heating outlet 134 of the heating flow path GP may serve as an inlet based on the circulation device C.

The first cooling flow path CP1 and the second cooling flow path CP2 may be partitioned from the heating flow path GP, and the first cooling flow path CP1 and the second cooling flow path CP2 may be connected to each other at the cooling outlets OP1 and OP2. The first cooling outlet OP1 may be formed between the guide front surface 131 and the connection passage 61a, and the second cooling outlet OP2 may be formed between the guide rear surface 135 and the connection passage 61a. The first cooling outlet OP1 and the second cooling outlet OP2 may be connected to each other between the guide side 132 forming the cooling outlet OP1, OP2 and the connection passage 61a. Accordingly, the first cooling outlet OP1 and the second cooling outlet OP2 may be connected to each other to be shaped in a roughly rectangle shape.

The first cooling outlet OP1 and the second cooling outlet OP2 may be connected to each other to form a continuous path. The flow path guide 130 and the connection passage 61a have rectangular forms, respectively. Therefore, the continuous cooling outlet OP1, OP2 formed by the first cooling outlet OP1 and the second cooling outlet OP2 may entirely have a rectangular channel structure. In other words, based on a plan structure, the heating outlet 134 having a rectangular form may be covered by the cooling outlet OP1, OP2 having a larger rectangular form.

The guide rear surface 135 may be formed with a vertical length shorter than the guide front surface 131. Accordingly, the guide rear surface 135 may be spaced apart from the lower plate 117 in an upward direction by a longer distance than the guide front surface 131. In other words, a lower end of the guide rear surface 135 is spaced upward apart from the bottom of the combustion chamber S5 more than a lower end of the guide front surface 131, so an entrance of the heating flow path GP may be open toward the burner 120. Through the entrance of the heating flow path GP, a flame F of the burner 120 may be guided into the heating flow path GP. Therefore, the entrance of the heating flow path GP may be formed between the lower end of the guide rear surface 135 and the lower plate 117.

A part or portion of the guide rear surface 135 may be bent, and a rear bent portion 135a may be provided. The rear bent portion 135a may extend toward the rear panel 20, more specifically, in parallel to an open direction of the flame hole 125. Referring to FIG. 19, the rear bent portion 135a may reduce a distance between a guide end portion 145a of the flame guide 140, which will be described hereinafter, and the flow path guide 130. A first gap G1 may be formed between the rear bent portion 135a and the guide end portion 145a as the rear bent portion 135a and the guide end portion 145a are spaced apart from each other by a predetermined distance. The secondary air may be introduced through the first gap G1 described above. In other words, the first gap G1 may be connected to the entrance of the heating flow path GP. When some of the air introduced from the external space is introduced through the first gap G1 between the rear bent portion 135a and the guide end portion 145a, the air may be the secondary air supplied to the burner 120. This secondary air may be supplied as a flame F generated through the flame hole 125 of the burner 120 to help the complete combustion.

The flow path guide 130 may include a guide fence 137. The guide fence 137 may be provided at a lower end of the guide front surface 131. The guide fence 137 may protrude in a direction inclined to the burner 120 with respect to the vertical direction. The guide fence 137 may guide air heated by the burner 120 toward the heating flow path GP. The guide fence 137 may enable air heated by the flame F of the burner 120 not to move to the first cooling flow path CP1 and to move along the heating flow path GP to the heating chamber S2.

Referring to FIG. 18, a lower end of the guide fence 137 may be provided at a position lower than the flame hole 125. Reference numeral H1 may indicate an imaginary horizontal line that passes through a lowest flame hole 125 among the multiple flame holes 125 of the burner 120. It may be shown that each flame hole 125 of the burner 120 is located higher than the lower end of the guide fence 137. Accordingly, when the flame F generated from each flame hole 125 heats air, the heated air may be guided higher than the lower end of the guide fence 137. Further, when the flame F extends lengthwise in the frontward-rearward direction, the guide fence 137 may prevent the flame F from facing the first cooling flow path CP1.

Next, the flame guide 140 will be described. The flame guide 140 may guide the flame a direction in which the flame of the burner 120 is generated. The flame guide 140 may guide a flow of air so that the air heated by the burner 120 moves to the heating flow path GP. The flame guide 140 may be arranged between the burner 120 and the flow path guide 130. Accordingly, the flame F of the burner 120 and the heated air may be guided toward the flow path guide 130 along the flame guide 140.

In this embodiment, the flame guide 140 may be arranged between an upper portion of the flame holes 125 and the heating flow path GP of the flow path guide 130. The flame F generated from each flame hole 125 is blocked by the flame guide 140, and does not extend upward anymore, thereby facing the heating flow path GP along the flame guide 140. Therefore, the burner 120 may concentrically heat air moving upward through the heating flow path GP.

The flame guide 140 may be made of a material having high heat resistance. The flame guide 140 may be made of a flat material. The flame guide 140 may extend lengthwise in the longitudinal direction of the burner 120. The flame guide 140 may have a length that can completely cover an area where the flame holes 125 are arranged.

In this embodiment, the flame guide 140 may include a fixation body 141 and a guide blade 145. The fixation body 141 and the guide blade 145 may be a connected flat structure. The fixation body 141 may be coupled to the burner 120. The fixation body 141 may be coupled to a surface of the burner 120. The fixation body 141 may be shaped in a curved surface corresponding to the surface of the burner 120. Referring to FIG. 13, the fixation body 141 may be coupled to a guide coupling part or portion 121b provided on the surface of the burner 120. As described above, a part or portion of the flame guide 140, that is, the fixation body 141 is coupled to the burner 120, and the guide blade 145 may extend from the fixation body 141 toward the flow path guide 130. More specifically, the guide end portion 145a provided at an end of the guide blade 145 may extend in a direction inclined upward to the connection passage 61a.

Referring to FIG. 19, the flame F may extend at a lower portion of the guide blade 145. A part or portion of the heating flow path GP guiding heated air may be formed between a lower portion of the flame guide 140 and a bottom surface of the burner case 110. The lower portion of the guide blade 145 and the lower plate 117 are spaced apart from each other to provide a space, and the space may form a part or portion of the heating flow path GP. The lower portion of the guide blade 145 may be considered a flame space where the flame F is generated.

Air introduced from the external space may move to an upper portion of the guide blade 145. An external air space S6 may be provided between the upper portion of the guide blade 145 and the upper plate 113 and the secondary air introduced from the external space may be introduced into the external air space S6. The external air space S6 may form the second cooling flow path CP2. The air passing through the external air space S6 may cool the surrounding portion and may be transferred to the lower portion of the frame 60 through the cooling outlet OP2.

A part or portion of the secondary air passing through the external air space S6 enters the heating flow path GP through the first gap G1 between the guide end portion 145a and the rear bent portion 135a to help complete combustion of the burner 120. As described above, a part or portion of the secondary air entering the external air space S6 may move to the first gap G1 between the guide end portion 145a and the rear bent portion 135a to join the heating flow path GP.

More specifically, the external air space S6 may be formed between the flame guide 140 and the frame rear surface 65 covering the upper opening 116 of the burner case 110. External air introduced into the external air space S6, based on the rear bent portion 135a, (i) may enter the second cooling outlet OP2, which is an outlet of the second cooling flow path CP2, through a second gap G2 formed at an upper portion of the rear bent portion 135a (direction of arrow \textcircled{9}), and (ii) may join with the entrance of the heating flow path GP through the first gap G1 formed between the rear bent portion 135a and the guide end portion 145a. The air joining the heating flow path GP may be transferred to the flame generated from the burner 120 to be the secondary air helping complete combustion.

With the above configuration, the external air space S6 may form a part or portion of the second cooling flow path CP2. Air passing through the second cooling flow path CP2 may be transferred to the lower portion of the frame 60 through the second cooling outlet OP2 to perform the cooling function.

An end of the rear bent portion 135a may protrude toward the rear panel 20 more than the guide end portion 145a, thereby guiding the secondary air toward the entrance of the heating flow path GP. The rear bent portion 135a may be arranged between the guide end portion 145a and the flow path entrance end 65a. Based on the rear bent portion 135a, a junction part or portion (the first gap part G1) of the heating flow path GP formed between the rear bent portion 135a and the guide end portion 145a and the flow path entrance end 65a, and a connection part or portion G2 of the second cooling outlet OP2 formed between the rear bent portion 135a and the flow path entrance end 65a may be partitioned. With the above configuration, the second gap G2, that is, the connection part or portion G2 between the rear bent portion 135a and the flow path entrance end 65a may be connected to the second cooling outlet part OP2. In this embodiment, the second gap G2 may be positioned higher than the burner 120.

As another example, the flame guide 140 and the burner case 110 are spaced apart from each other to form the joint portion (the first gap G1). When the flow path guide 130 is omitted, and the guide end portion 145a of the flame guide 140 extends to a position adjacent to the connection passage 61a, the junction portion (the first gap G1) may be formed between the guide end portion 145a and the connection passage 61a. As another example, the flow path guide 130 is integrated with the burner case 110, and the junction portion (the first gap G1) may be formed between the guide end portion 145a and one end portion of the flow path guide 130.

An upward inclined structure of the guide blade 145 may form the external air space S6 into a space with a width gradually reduced toward the guide end portion 145a. Accordingly, a velocity of air may increase as the air goes to the guide end portion 145a. The air with increased velocity may be efficiently transferred to the second cooling flow path CP2 or the first gap G1.

The external air space S6 may be a kind of insulation space S4 formed between the burner 120 and the frame 60. The external air space S6 may reduce an amount of radiant heat of the burner 120 transferred to the lower portion of the frame 60, more specifically, to a part or portion where the frame lower surface 61 and the frame rear surface 65 are connected to each other. This may increase a durability of the frame 60.

External air passing through the external air space S6 may cool the flame guide 140 while passing through the flame guide 140. Heat exchange is performed when the external air space S6 is in surface-contact with the surface of the flame guide 140, so the temperature of the flame guide 140 may be reduced, and overheating of the flame guide 140 may be prevented. In FIG. 19, arrow \textcircled{8} indicates a flow direction of air moving along the surface of the burner 120. The air moved as described above may cool the flame guide 140 while passing through the flame guide 140. In addition, air moving continuously along the path that is the external air space S6 and the second cooling flow path CP2 may join the second cooling outlet OP2 of the second cooling flow path CP2, or may join the heating flow path GP through the first gap G1.

The air joining the heating flow path GP through the first gap G1 may be turned into a primarily heated state by heat exchange in the process in which the air cools the flame guide 140 while passing through the flame guide 140. Therefore, heat loss caused by the secondary air supplied from the external space may be minimized.

An end of the guide blade 145, that is, the guide end portion 145a may extend only to a range where the guide blade 145 does not intrude into the heating flow path GP. Referring to FIG. 18, the guide end portion 145a extending from the guide rear surface 135 to a position set back toward the burner 120 is illustrated. Based on an imaginary line that extends in the vertical direction in which the guide rear surface 135 is provided, the guide end portion 145a is arranged in an area that does not cross the imaginary line. Then, it is possible to prevent the guide end portion 145a from intruding into the heating flow path GP and interrupting a flow of air passing through the heating flow path GP.

Next, a process in which external air is heated by the heating device 100 and then supplied to the circulation device C will be described with reference to FIG. 19. First, after mixed gas in which air and gas are mixed is supplied to the burner 120, the spark plug 122 ignites, and then a flame is generated from each flame hole 125 of the burner 120. Arrow \textcircled{1} indicates a flow direction of the mixed gas, and arrow \textcircled{2} indicates a direction in which a flame is generated through each flame hole 125.

External air introduced for combustion of the mixed gas in the burner 120 may be divided into primary air and secondary air. The primary air may be introduced into the combustion chamber S5 through the first inlet (23, 119, referring to FIG. 21). At the same time, when gas supplied from the external space is sprayed through a nozzle, the gas sprayed through the nozzle and the primary air may be introduced together into the mixing tube 123. As described above, the gas and the air introduced into the mixing tube 123 may be mixed when flowing inside of the mixing tube 123 toward the burner body 121 to generate the mixed gas.

The secondary air is required to perform complete combustion of the mixed gas, and the secondary air may be supplied in a path different from the primary air. In the enlarged view of FIG. 11, the second inlet IP2 may be provided between the heating device 100 and the rear panel 20. The second inlet IP2 may be a predetermined space formed by the heating device 100 and the rear panel 20 being separated from each other.

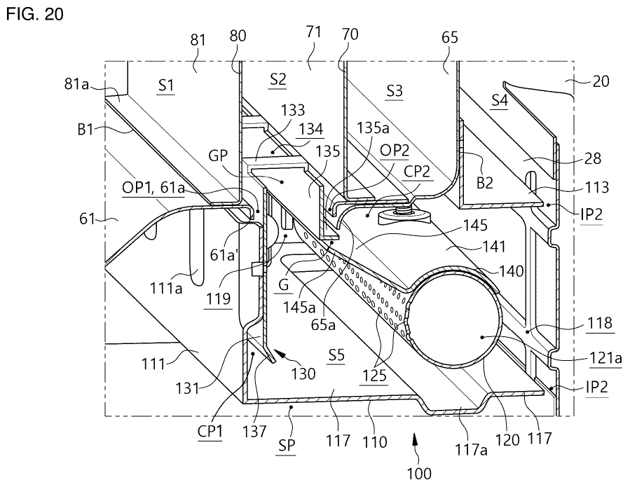

More specifically, with reference to FIGS. 19 and 20, the second inlet IP2 may be formed in a gap between the burner case 110 and the surface of the rear panel 20. The second inlet IP2 may be provided between a rear end of the lower plate 117 forming the burner case 110 and the rear panel 20. Accordingly, the second inlet IP2 may be provided closer to the outer case 10, that is, the rear panel 20 than the connection passage 61a.

The second inlet IP2 may be provided along the surface of the outer case 10. External air may move along the surface of the outer case 10, and naturally be guided to the second inlet IP2. In this embodiment, the second inlet IP2 may be provided along the surface of the rear panel 20 of the outer case 10. More specifically, the second inlet IP2 may be provided in parallel to the surface of the rear panel 20.

Referring to FIG. 20, the rear end of the lower plate 117 facing the surface of the rear panel 20 is spaced apart from the rear panel 20, and the second inlet IP2 is formed therebetween. In this embodiment, the panel opening 23 is open in the rear panel 20, and the panel opening 23 may be covered with the shielding cover 28. Accordingly, the second inlet IP2 may be formed between the lower plate 117 and the shielding cover 28.

The second inlet IP2 may be provided between a rear end of the upper plate 113 and the rear panel 20. The rear end of the upper plate 113 may also be spaced apart from the surface of the rear panel 20, and a gap may be formed therebetween, and the gap may be the second inlet IP2. Accordingly, external air serving as the secondary air may be simultaneously introduced through two second inlets IP2 with different heights from each other.

When an insulator is filled in the insulation space S4, an upper portion of the upper plate 113 is filled with the insulator to reduce the path into which air may be introduced. In this case, the lower portion of the insulation space S4 is provided without the insulator to serve as a predetermined space for the second inlet IP2.

In this embodiment, the second inlet IP2 may be formed in a mounting direction of the burner 120, that is, the longitudinal direction of the burner 120. External air introduced through the second inlet IP2 is used as the secondary air for combustion of the burner 120, so it is necessary to supply the external air evenly to all the flame holes 125 of the burner 120. The second inlet IP2 may extend in the longitudinal direction of the burner 120. The second inlet IP2 may be provided in a leftward-rightward direction (Y-axial direction in FIG. 1) like the burner 120.

The chamber opening 118 may be formed in the burner case 110, and the second inlet IP2 may be connected to the chamber opening 118. The chamber opening 118 is a portion open rearward of the burner case 110, so the second inlet IP2 may be connected to the chamber opening 118. Accordingly, external air introduced into the second inlet IP2 may flow toward the burner 120 through the chamber opening 118. Of course, as illustrated in FIG. 22, the chamber opening 118 is covered with the rear panel 20 or the shielding cover 28, and therefore, the introduced air does not flow out rearward and may face the burner 120.

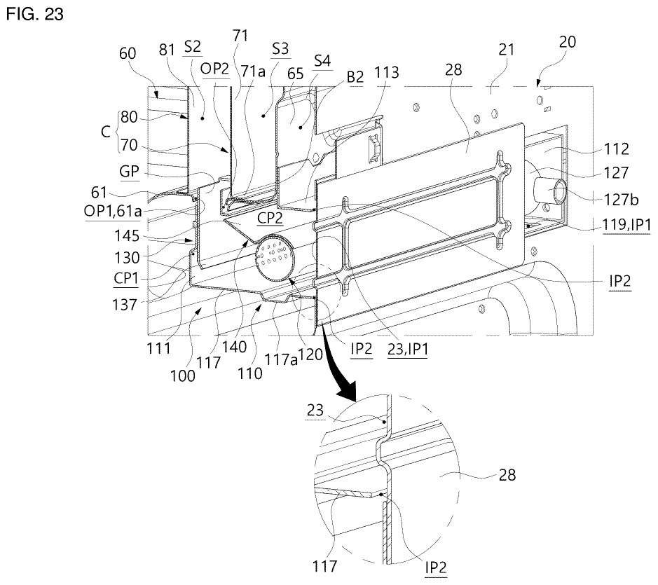

Referring to FIG. 23, the second inlet IP2 is illustrated enlarged. As illustrated in the drawing, the second inlet IP2 may be formed in a gap between the lower plate 117 and the shielding cover 28. As described above, the second inlet IP2 may be provided behind the burner case 110 closer to the rear panel 20 than the front plate 111 of the burner case 110. The external air may cool the lower plate 117 and the uneven portion 117a through the air inlet passage SP and then enter the second inlet IP2.

More specifically, external air flowing in the installation space IS may be introduced, at an end point of the air inlet passage SP that is blocked by the outer case 10, into the heating device 100 through the second inlet IP2. In this embodiment, the end point may be formed at a portion that is blocked by the rear panel 20 of the outer case 10. Accordingly, external air is introduced into the second inlet IP2 after passing through the surface of the heating device 100 along the air inlet passage SP, so the cooling function by the external air may be efficiently performed.

The second inlet IP2 may extend to a length equal to or longer than the length of the burner 120. Then, the second inlet IP2 may provide the secondary air evenly on a wide area of the burner 120.

The second inlet IP2 may be provided closer to the outer case 10 than the connection passage 61a. Then, air introduced into the second inlet IP2 may sufficiently pass through the combustion space S5 and the second heating flow path CP2 and then enter the second cooling outlet OP2. In this embodiment, the second inlet IP2 may be provided closer to the rear panel 20 than the connection passage 61a.

As described above, when the secondary air is introduced through the second inlet IP2, the burner 120 may completely burn the mixed gas. In this embodiment, the heating device 100 is spaced apart from the circulation fan 93 and arranged in an independent space. Therefore, the heating device 100 is not directly supplied with the secondary air from the circulation fan 93 and may be supplied with the secondary air through the above-described secondary air supply structure. In other words, the heating device 100 may suction external air as the secondary air without additional components, such as a motor, or a fan, for example. As another example, a separate flow path and a fan to induce the secondary air may be arranged in the heating device 100.

More specifically, in this embodiment, when air heated in the combustion chamber S5 moves to the heating chamber S2 through natural draft or movement of the circulation fan 93, the pressure of the combustion chamber S5 is lowered. When the pressure of the combustion chamber S5 is lowered below that of the external space, that is, the pressure of the installation space IS, external air existing in the installation space IS may be naturally introduced into the combustion chamber S5 through the second inlet IP2. As described above, when the external air is introduced into the combustion chamber S5 by the negative pressure of the combustion chamber S5, a part or portion of the external air may be used as the secondary air, and a remaining part or portion of the external air may be used to cool components, such as the lower portion of the frame 60.

Referring to FIG. 19, a view illustrates a flow in which the air supplied from the external space is used as the secondary air. Air passing through the air inlet passage SP (direction of arrow \textcircled{4}) and cooling the lower plate 117 and the uneven portion 117a may be introduced to the combustion chamber S5 through the second inlet IP2 (direction of arrow \textcircled{5}).

As described above, a part or portion of the external air introduced into the combustion chamber S5 may move along the lower plate 117 and pass through a lower portion of the burner 120 (direction of arrow \textcircled{6}) and then be supplied to each flame hole 125 of the burner 120 as the secondary air. The secondary air may facilitate complete combustion of mixed gas in the flame holes 125.

In FIG. 19, arrow \textcircled{3} indicates a flow of heated air. The complete combustion is performed at the flame holes 125 by the secondary air described above to generate flames, and when the air of the combustion chamber S5 is heated by flame, the heated air may move through the heating flow path GP. The air heated through the heating flow path GP may be transferred to the heating chamber S2.

Referring to FIG. 11, the high temperature air transferred to the heating chamber S2 (direction of arrow \textcircled{2}) may be mixed with the air of the cooking chamber S1 suctioned to the heating chamber S2 by the circulation fan 93 (direction of arrow \textcircled{1}). The mixed air moves to the discharge chamber S3 and then may be supplied to the cooking chamber S1 through the discharge holes 75, 85 (direction of arrow \textcircled{3}). In FIG. 11, arrow \textcircled{4} indicates a direction in which external air moves to the lower portion of the heating device 100, arrow \textcircled{5} and arrow \textcircled{6} indicate air flows flowing along the first cooling flow path CP1 and the second cooling flow path CP2.

As described above, in this embodiment, the heating device 100 is arranged at the lower portion of the circulation device C circulating air of the cooking chamber S1, and is provided in a space separated from the circulation device C. This structure may prevent flames of the burner 120 from being affected by the fan even when the circulation fan 93 is operated. Accordingly, a separate stabilizer is unnecessary, and a burner reflector for protecting an inner wall of the cooking chamber S1 from flames is omitted.

More specifically, in embodiments disclosed herein, air heated in the heating device 100 has a low density and a large buoyancy as the air is heated and the volume increases, and the heated air may rise due to natural draft. A specific structure related to the circulation of air will be described hereinafter. Therefore, even when the circulation fan 93 is not operated, heated air may be supplied to the cooking chamber S1.

A part or portion of the air flowing along the first cooling flow path CP1 of the lower plate 117 may move toward the front plate 111 and then be introduced between the front plate 111 and the guide front surface 131. Next, the air may enter the first cooling flow path CP1 (direction of arrow \textcircled{7}) formed between the front plate 111 and the guide front surface 131 by the spacer 111a.

Further, external air may be introduced through upper second inlet IP2 of the second inlets IP2 (direction of arrow \textcircled{5}′). The introduced external air may flow along the second cooling flow path CP2 over the upper surface of the burner 120. A part or portion of the air introduced through lower first inlet IP1 may also move along the upper surface of the burner 120 (direction of arrow \textcircled{8}), so the air may be mixed with the air introduced through the upper second inlet IP2.

The mixed air moves along the upper surface of the flame guide 140 to cool the flame guide 140. The air moving continuously along the second cooling flow path CP2 over the flame guide 140 may enter the second cooling outlet OP2 (direction of arrow \textcircled{9}). The air transferred toward the second cooling outlet OP2 through a gap between the guide end portion 145a of the flame guide 140 and the flow path entrance end 65a may rise and cool the frame lower surface 61 and the lower portion of the circulation device C.

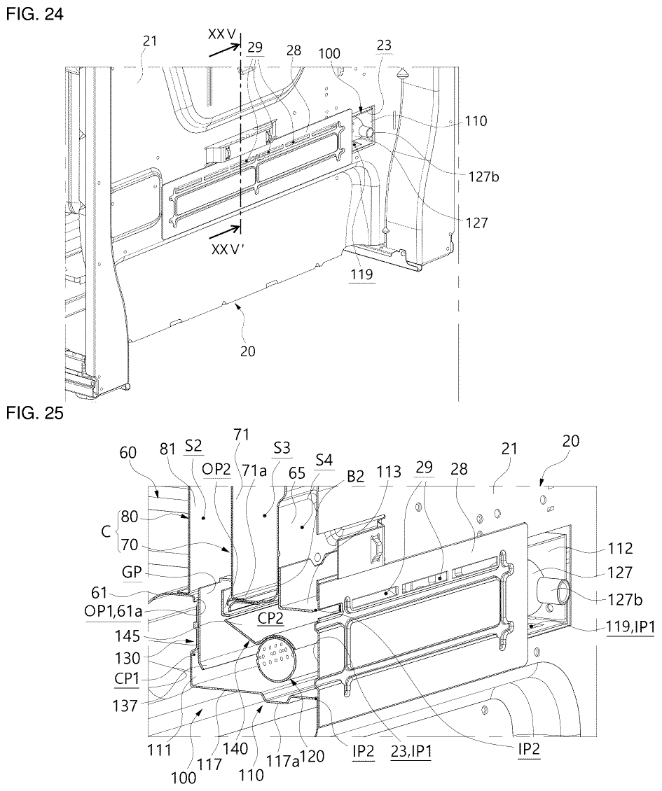

FIGS. 24 and 25 illustrate a rear lower structure of an oven according to another embodiment. In describing components different from the above-described embodiment, a cover hole 29 may be formed in shielding cover 28 covering panel opening 23 of rear panel 20. The cover hole 29 may be formed through the shielding cover 28. External air may be introduced through the cover hole 29 into heating device 100, that is, into combustion chamber S5.

Referring to FIG. 25, the combustion chamber S5 is located in front of the cover hole 29. The cover hole 29 is connected to the chamber opening 118, so external air may pass through the cover hole 29 to the combustion chamber S5. As described above, a part or portion of the air introduced into the combustion chamber S5 through the cover hole 29 may be supplied to the burner 120 to be used as the secondary air. Further, a part or portion of the introduced air may be transferred to the second cooling flow path CP2 to cool components. Accordingly, the cover hole 29 may be considered to form a part or portion of the second inlet IP2. Of course, a part or portion of the air introduced through the cover hole 29 may be used as the primary air.

The cover hole 29 may have a long hole form that is provided or extends lengthwise in a longitudinal direction of the shielding cover 28, that is, extends parallel to the extension direction of the burner 120. Multiple cover holes 29 may be provided in the shielding cover 28 at constant intervals. As described above, external air introduced through the cover holes 29 formed in the extension direction of the burner 120 may be evenly supplied to the flame holes 125 of the burner 120.

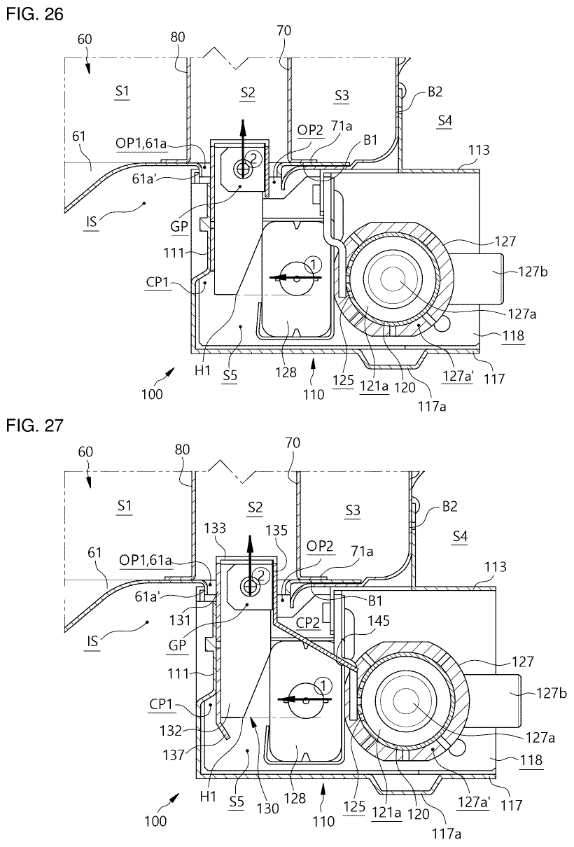

FIG. 26 is a cross-sectional view of a heating device according to another embodiment. In describing different components from the above-described embodiments, heating device 100 does not include a flow path guide formed as a separate component, and the flow path guide may be integrated with burner case 110. In other words, a flow path guide (not given reference numeral) forming heating flow path GP is integrated with the burner case 110 of the heating device 100. Accordingly, a flow path guide is not separately provided and coupled to the burner case, and the flow path guide integrally provided may partition the combustion chamber S5.

In FIGS. 27 to 30, structure of heating device 100 according to another embodiment is illustrated. In describing components different from the above-described embodiments, the heating device 100 may include guide blade 145 to guide flames of burner 120. The guide blade 145 may be integrated with flow path guide 130. The flow path guide 130 may not only guide the heated air to heating chamber S2, but also guide the extension direction of the flames.

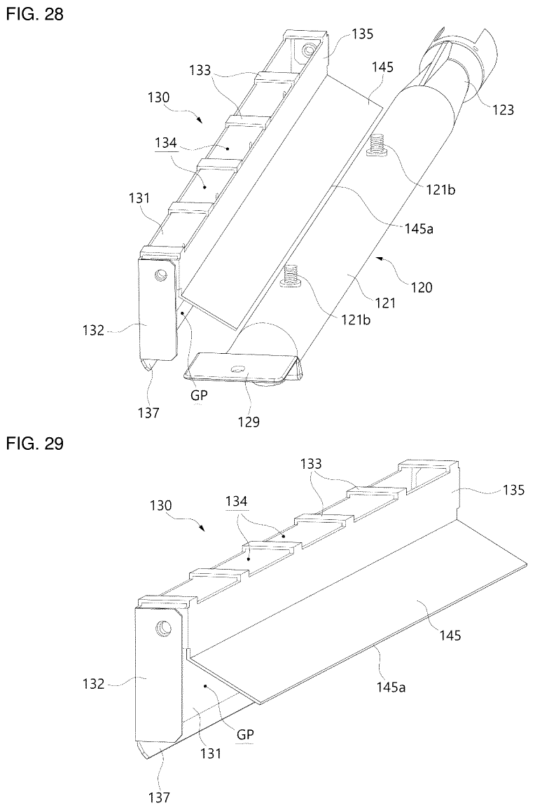

Referring to FIG. 28, the guide blade 145 may extend from guide rear surface 135 of the flow path guide 130. The guide blade 145 may be provided in a direction inclined downward from the guide rear surface 135 toward the burner 120. The guide blade 145 may have a roughly flat structure. The guide blade 145 may extend in a same direction as the guide rear surface 135. The guide blade 145 may have a length longer than or at least equal to a length of an area where the flame holes 125 of the burner 120 are arranged.

An end portion 145a of the guide blade 145 may extend to a position adjacent to the surface of the burner 120. The end portion 145a of the guide blade 145 may be spaced apart from the surface of the burner 120 at a predetermined distance. As described above, air may flow into a gap in which the end portion 145a of the guide blade 145 is spaced apart from the surface of the burner 120. After external air is introduced into combustion chamber S5, the external air may be transferred between the end portion 145a of the guide blade 145 and the surface of the burner 120. The air transferred as described above may be supplied to the flame holes 125 of the burner 120 and used as the secondary air.

Referring to FIG. 29, heating flow path GP may be formed among the guide blade 145, guide front surface 131, and guide side 132. Air heated by the burner 120 may rise through the heating flow path GP. The guide blade 145 may serve to guide the heated air to the heating flow path GP. The guide blade 145 and the guide front surface 131 may form the heating flow path GP in which a width is gradually reduced in an upward direction, thereby increasing a velocity of flowing raised air.

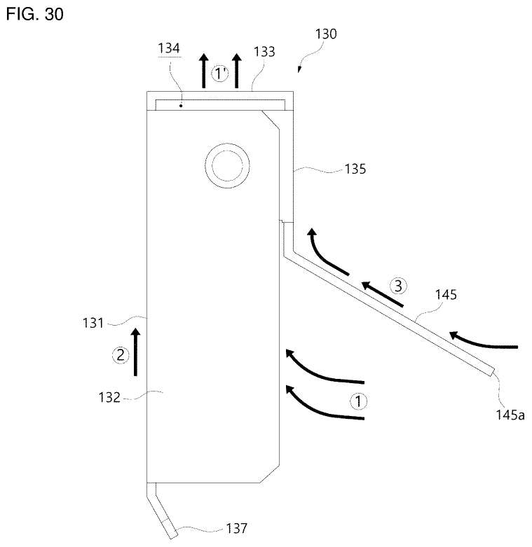

Referring to FIG. 30, a flow of air entering the heating flow path GP is indicated with arrow \textcircled{1}. Air passing through the heating flow path GP may enter the combustion chamber S5 (referring to the direction of arrow \textcircled{1}′). At the same time, air for cooling may flow along the surface of the flow path guide 130 (direction of arrow \textcircled{2}). Air may cool the flow path guide 130 while passing along the surface of the guide front surface 131 and may move to the first cooling flow path CP1. Further, a part or portion of external air may pass above the guide blade 145 and may cool the guide blade 145 (direction of arrow \textcircled{3}). The air cooling the guide blade 145 may move to the second cooling flow path CP2.

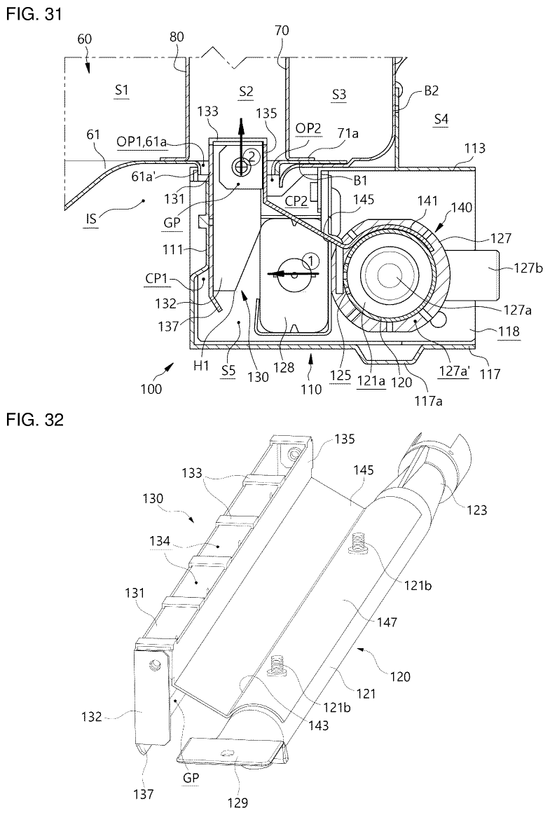

FIGS. 31 to 33 illustrate structure of heating device 100 according to another embodiment. In describing components different from the above-described embodiments, guide blade 145 may be arranged between burner 120 and flow path guide 130 which form the heating device 100. The guide blade 145 may be integrated with the flow path guide 130. The flow path guide 130 may not only guide the heated air to heating chamber S2, but also guide an extension direction of flames.

Referring to FIG. 31, the guide blade 145 may extend from guide rear surface 135 of the flow path guide 130. The guide blade 145 may be provided in a direction inclined downward from the guide rear surface 135 toward the burner 120. The guide blade 145 may have a roughly flat structure. The guide blade 145 may extend in a same direction as the guide rear surface 135. The guide blade 145 may have a length longer than or at least equal to a length of an area where flame holes 125 of burner 120 are arranged.

Referring to FIG. 32, a first end portion of the guide blade 145 may be connected to the guide rear surface 135, and a second end portion of the guide blade 145 may include a burner fixation part or portion 147 that is in close contact with the surface of the burner 120. The burner fixation portion 147 in close contact with the surface of the burner 120 may be coupled to guide coupling portion 121b of the burner 120.

A depressed portion 143 may be formed at a portion where the guide blade 145 extends to the burner fixation portion 147. From the depressed portion 143, the burner fixation portion 147 may cover the surface of the burner 120.

The guide blade 145 connects the guide rear surface 135 and the burner 120 to each other, so an upper portion and a lower portion may be partitioned with the guide blade 145 as a center. Referring to FIG. 31, a space connected to the second cooling flow path CP2 may be formed in an upper portion of the guide blade 145. A lower portion of the guide blade 145 may be a space connected to the heating flow path GP.

Referring to FIG. 32, the heating flow path GP may be formed among the guide blade 145, guide front surface 131, and guide side 132. Air heated by the burner 120 may be raised through the heating flow path GP. The guide blade 145 may serve to guide the heated air to the heating flow path GP. The guide blade 145 and the guide front surface 131 may form the heating flow path GP in which a width is gradually reduced in an upward direction, thereby increasing a velocity of rising air.

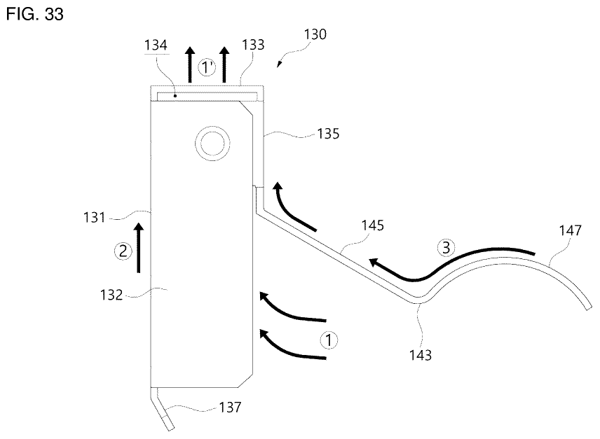

Referring to FIG. 33, a flow of air entering the heating flow path GP is indicated with arrow \textcircled{1}. Air passing through the heating flow path GP may enter the combustion chamber S5 (referring to the direction of arrow \textcircled{1})′). At the same time, air for cooling may flow along the surface of the flow path guide 130 (direction of arrow \textcircled{2}). Air may cool the flow path guide 130 while passing along the surface of the guide front surface 131 and may move to the first cooling flow path CP1. Further, a part or portion of external air may pass above the guide blade 145 and may cool the guide blade 145 (direction of arrow \textcircled{3}). The air cooling the guide blade 145 may move to the second cooling flow path CP2.

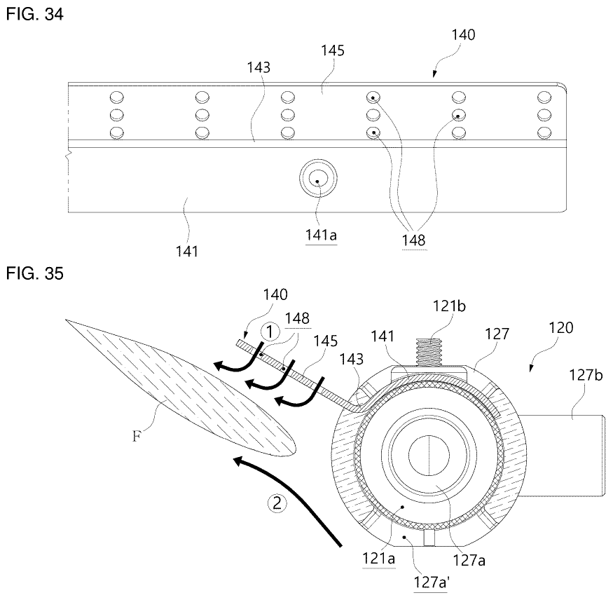

FIGS. 34 to 35 illustrate structure of heating device 100 according to another embodiment. In describing components different from the above-described embodiments, the heating device 100 may include flame guide 140. The flame guide 140 may be coupled to the surface of burner 120. The flame guide 140 may guide a direction of flames generated from each flame hole 125 of the burner 120.

The flame guide 140 may include fixation body 141 coupled to the burner 120. The fixation body 141 may be shaped in a curved surface to correspond to the surface of the burner 120. The fixation body 141 may include a coupling hole 141a into which guide coupling portion 121b of the burner 120 is inserted.

The guide blade 145 may be connected to the fixation body 141. The guide blade 145 may guide a direction of a flame of the burner 120 and guide air heated by the flame toward the heating flow path GP. The guide blade 145 may have a roughly disc structure. The guide blade 145 may extend from the fixation body 141 at depressed portion 143 as a start point.

The guide blade 145 may include an air introduction hole 148. The air introduction hole 148 may be formed through the guide blade 145. Each air introduction hole 148 may form a path through which air passes. A part or portion of air moving along an upper portion of the guide blade 145 may pass through the air introduction hole 148 and move downward, that is, toward the flame holes 125 of the burner 120. The air may serve as the secondary air to help combustion of the burner 120 and prevent flames from extending excessively long.

Multiple air introduction holes 148 may be provided. In this embodiment, the air introduction holes 148 may form a total of 3 rows along a longitudinal direction of the air introduction holes 148. The air introduction holes 148 in 3 rows may be arranged at equivalent intervals. Air may be efficiently introduced to a front space of the burner 120 through the holes.

Referring to FIG. 35, a part or portion of air moving along the upper portion of the guide blade 145 may move downward through the air introduction holes 148 (direction of arrow \textcircled{1}). The air moving downward may be supplied to the front space of the burner 120. The air supplied as described above may serve as the secondary air generating flames. In the drawing, F indicates a flame. As described above, air passing through the air introduction holes 148 may help complete combustion of the mixed gas to induce efficient generation of the flame. At the same time, air flowing through the lower portion of the burner 120 (direction of arrow \textcircled{2}) may also serve as the secondary air to help complete combustion of the mixed gas.

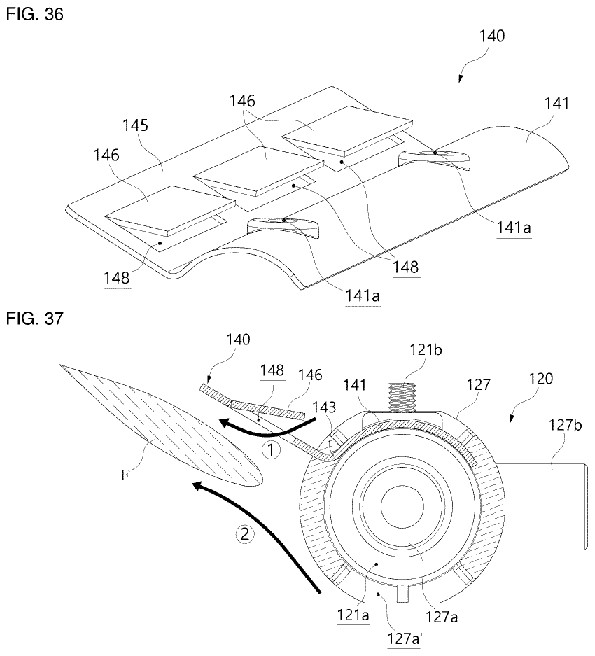

FIGS. 36 to 37 illustrate structure of heating device 100 according to another embodiment. In describing components different from the above-described embodiments, the heating device 100 may include flame guide 140. The flame guide 140 may be coupled to the surface of burner 120. The flame guide 140 may guide a direction of flames generated from each flame hole 125 of the burner 120.

The flame guide 140 may include fixation body 141 coupled to the burner 120. The fixation body 141 may be shaped in a curved surface to correspond to the surface of the burner 120. The fixation body 141 may include a coupling hole 141a into which guide coupling portion 121b of the burner 120 is inserted.

The guide blade 145 may be connected to the fixation body 141. The guide blade 145 may guide a direction of the flame of the burner 120 and guide air heated by the flame toward the heating flow path GP. The guide blade 145 may have a roughly disc structure. The guide blade 145 may extend from the fixation body 141 at depressed portion 143 as a start point.

The guide blade 145 may include an air guide 146. The air guide 146 may have a form in which a part or portion of the guide blade 145 is cut and then lifted. More specifically, the air guide 146 may have a form of a cantilever that extends from the guide blade 145.

A spacing distance by which an end portion of the air guide 146, that is, a free end of the cantilever is spaced apart from the guide blade 145 may be maximized. In other words, the air guide 146 may extend in a direction in which a distance between the air guide 146 and each air introduction hole 148 increases gradually. Accordingly, air hitting on the air guide 146 may naturally move to a lower space of the air guide 146.

Each air introduction hole 148 may be provided below the air guide 146. Each air introduction hole 148 may be considered a hole remaining after the air guide 146 is bent from the guide blade 145. Each air introduction hole 148 may form a path through which air passes. A part or portion of air moving along the upper portion of the guide blade 145 may be blocked by the air guide 146 and then may be guided into each air introduction hole 148.

As described above, the air passing through each air introduction hole 148 may move downward, that is, toward each flame hole 125 of the burner 120. The air may serve as the secondary air to help combustion of the burner 120 and prevent flames from extending excessively long.

Multiple guides 146 and multiple air introduction holes 148 may be provided. In this embodiment, 3 air guides 146 and 3 air introduction holes 148 are provided in the longitudinal direction of the guide blade 145. The multiple air guides 146 and the multiple air introduction holes 148 may be arranged at equivalent intervals. Air may be efficiently introduced through the multiple air introduction holes 148 toward the front space of the burner 120.

Referring to FIG. 37, a part or portion of air moving along the upper portion of the guide blade 145 may be blocked by the multiple air guides 146 and move downward through the multiple air introduction holes 148 (direction of arrow \textcircled{1}). The air moving downward may be supplied to the front space of the burner 120. The air supplied as described above may serve as the secondary air generating flames. In the drawing, F indicates a flame. As described above, air passing through the air introduction holes 148 may help complete combustion of the mixed gas to induce efficient generation of the flame. At the same time, air flowing through the lower portion of the burner 120 (direction of arrow \textcircled{2}) may also serve as the secondary air to help complete combustion of the mixed gas.

Embodiments disclosed herein are provided to solve problems of the related art. Embodiments disclosed herein provide a heating device for heating air into an independent space separately from a circulation device for circulating air of a cooking chamber.

Another objective of the present disclosure is to efficiently supply secondary air into a heating device.

Yet another objective of the present disclosure is to cool a heating device and surrounding components by using air flowing into the heating device.

Still another objective of the present disclosure is to supply air heated by a heating device into a cooking chamber oven when a circulation fan is not operated.

Still another objective of the present disclosure is to arrange a heating device at a lower portion of a cooking chamber to prevent radiant heat of a burner from being transferred to a wall surface of the cooking chamber.

Still another objective of the present disclosure is to enable a flame generated from a heating device to be concentrated air supplied from the heating device to a circulation device.

According to the features of the present disclosure to achieve the above-described objectives, in an aspect of the present disclosure, there is provided a cooking appliance may include an outer case, and a frame disposed in the outer case. The frame may include a cooking chamber. The cooking appliance of the present disclosure may include a circulation device having a circulation chamber connecting with the cooking chamber. The heating device may include a combustion chamber connected to the circulation chamber. The heating device may include a burner heating air introduced into the combustion chamber. At this point, the heating device may include a first inlet part open toward a surface of the burner. A second inlet part may be provided between the heating device and the outer case and connected to the combustion chamber. The external air introduced through the second inlet part may be used as the secondary air supplied to the burner to facilitate the complete combustion of gas.

In addition, the heating device may be arranged at a lower portion of the circulation device. By this structure, even when the circulation fan of the circulation device is operated, a flame of the burner is not affected by the fan, so a stabilizer may be omitted, and a burner reflector for protecting the inner wall of the cooking chamber from the flame may be omitted.

In addition, the frame may include a connection passage connecting the circulation chamber and the combustion chamber to each other. The heating device may be arranged opposite to the circulation device with the connection passage located therebetween. Then, a flow path in the circulation device and a flow path of the heating device may form a vertically continuous flow path. Air heated by the heating device may be raised along the continuous flow path by natural draft and then may be supplied into the cooking chamber.

In addition, the second inlet part may be provided such that the heating device and a surface of the outer case facing the heating device are spaced apart from each other. As described above, as the second inlet part is provided at a portion between the two parts spaced apart from each other, there is not necessary to install a separate pipe or add an air supply device to the cooking appliance to improve the second inlet part.

Furthermore, the heating device may be disposed in one direction along a rear edge of a lower portion of the frame. The second inlet part may be provided between the heating device and the outer case in the direction. Accordingly, the second inlet part may be provided over a long section and may supply a larger amount of external air to the combustion device.

In addition, the second inlet part may be provided in a direction parallel to a surface of the outer case. External air may move along the surface of the outer case, and naturally be guided to the second inlet part.

Furthermore, the second inlet part may extend longer than the length of the burner.

In addition, an air inlet passage may be formed at a lower portion of the heating device and air may flow in the air inlet passage. The second inlet part may be provided at an end point of the air inlet passage. Accordingly, external air may be introduced into the second inlet part after passing through the surface of the heating device along the air inlet passage, so the cooling function by the external air may be efficiently performed.

Furthermore, a rear panel constituting the outer case may be disposed opposite to an entrance of the cooking chamber. The second inlet part may be provided by spacing the heating device and the rear panel from each other.

In addition, the installation space may be provided between the outer case and the frame. The heating device may be arranged in the installation space. As described above, the heating device is arranged outside the cooking chamber, and the volume of the cooking chamber is prevented from being reduced due to the space occupied by the heating device.

Furthermore, the outer case may include a panel opening allowing the installation space to be open toward the outside space of the outer case. The panel opening may be shielded by the shielding cover, and the shielding cover may have a cover hole open, and the cover hole may be connected to the second inlet part.

Furthermore, the heating device may be disposed in an installation space between the outer case and the frame. The installation space may form a path continued from a lower portion of the entrance of the cooking chamber to a rear surface portion of the outer case.

In addition, the heating device may have a chamber opening allowing the combustion chamber to be open to the rear side of the heating device. The second inlet part may be connected to the chamber opening.

Furthermore, the chamber opening may constitute a part of the first inlet part.

In addition, an air inlet passage may be formed at a lower portion of the heating device. The second inlet part may be provided at one end of the air inlet passage blocked by the outer case.

Furthermore, the heating device may have an uneven part protruding toward the air inlet passage. In addition, the uneven part may be provided at a lower portion of the burner. The uneven part may protrude toward the air inlet passage of the external air, a contact area with the external air may expand.

In addition, the frame may include a connection passage connecting the circulation chamber and the combustion chamber to each other. A flame guide may be arranged between the burner and the connection passage. The second inlet part and an upper space of the flame guide may form a connected path.

In addition, the first inlet part may be formed through a part of the heating device. The first inlet part may be connected to the installation space.

In addition, the circulation chamber may provide a first flow path connected to the cooking chamber. The combustion chamber may provide a second flow path transferring air heated by the burner to the first flow path, and

In addition, the first flow path and the second flow path may be connected to each other through a connection passage provided in the bottom surface of the frame in a height direction of the frame.

Furthermore, the burner may generate a flame in a first direction, and the circulation chamber and the combustion chamber may provide a flow path continued in a second direction perpendicular to the first direction.

In addition, the heating device may include a burner case and the burner mounted in the burner case. In addition, the burner case may include a front plate constituting a front surface of the combustion chamber, a side plate constituting a side surface of the combustion chamber, an upper plate constituting an upper surface of the combustion chamber, and a lower plate constituting a bottom surface of the combustion chamber. At this point, the second inlet part may be provided between one end portion of the lower plate and the surface of the outer case spaced apart from each other, or between one end portion of the upper plate and the surface of the outer case spaced apart from each other.

Furthermore, the circulation device and the heating device may be fixed to the surface of the frame at different positions. With the heating device fixed to the surface of the frame, the second inlet part may be provided at a gap between the heating device and the outer case spaced apart from each other.

In addition, the heating device may have a protrusion which further protrudes toward a surface of the outer case than the circulation device. The second inlet part may be provided between an end of the extension part and the outer case.

Furthermore, one end of the burner has a tube inlet open to be connected to a gas flow path in the burner. The first inlet part may be open toward the tube inlet through the heating device.

As described above, the cooking appliance according to according to embodiments disclosed herein has at least following advantages.

In the present disclosure, the burner may be arranged at a lower portion of the circulation device circulating air of the cooking chamber and may be provided inside the burner case that is a space independent from the circulation device. By this structure, even when the circulation fan of the circulation device is operated, a flame of the burner is not affected by the fan, so a stabilizer is not necessary, and a burner reflector for protecting the inner wall of the cooking chamber from the flame can be omitted. Eventually, the number of components and the assembly work hours of the cooking appliance are reduced, and the manufacturing cost is lowered, which is the effect.

Furthermore, a flame of the burner is free from a suction force of a fan of the circulation device, so the burner can generate more stable flame, and the cooking performance of the cooking appliance can be eventually improved.

In addition, the present disclosure may include the first inlet part in which external air is directly introduced toward the burner of the heating device and the second inlet part in which additional external air is introduced through a gap between the heating device and the outer case. The external air introduced through the second inlet part may be used as the secondary air supplied to the burner to facilitate the complete combustion of gas. Accordingly, the heating performance of the cooking appliance can be improved.

At this point, in the present disclosure, the combustion chamber in the heating device may have a negative pressure when air heated by the burner is raised upward to the heating chamber. With the negative pressure of the combustion chamber, external air can be naturally sucked into the combustion chamber through the second inlet part and be used as the secondary air. As described above, in the present disclosure, external air can be sucked even without a separate fan for suction of the secondary air, so a reduction of the number of components, simplification of the structure, and reduction of unnecessary energy to supply air can be achieved.

Furthermore, even when the circulation fan of the circulation device is not operated, external air may flow into the heating device, and therefore the present disclosure can provide a cooking method using only the heating device without using the circulation fan. Therefore, when the cooking appliance of the present disclosure is used, cooking food can be performed in more diverse methods.

In addition, the second inlet part may extend along an edge of a lower rear portion of the frame at a portion where the heating device and the outer case are spaced apart from each other. Accordingly, the second inlet part may be provided over a long section and may supply a larger amount of external air to the combustion device. This allows the complete combustion of the burner to be efficiently achieved.

Furthermore, in the present disclosure, the second inlet part may be respectively provided between the lower end of the heating device and the outer case and between the upper end of the heating device and the outer case. This structure allows external air to flow in various directions, thereby supplying a sufficient amount of air required for the combustion function of the burner.

In addition, in the present disclosure, the second inlet part may be provided at a portion where the heating device and the outer case are spaced apart from each other. As described above, as the second inlet part is provided at a portion between the two parts spaced apart from each other, there is not necessary to install a separate pipe or add an air supply device to the cooking appliance to improve the second inlet part. Therefore, the present disclosure has an effect that the structure to add the second inlet part is simple and processing costs are reduced.

Furthermore, in the present disclosure, the second inlet part may be provided along the surface of the outer case. External air may move along the surface of the outer case, and naturally be guided to the second inlet part. Accordingly, the secondary air can be efficiently supplied.

In addition, the heating device of the present disclosure may be disposed in the installation space formed between the frame defining the cooking chamber and the outer case covering the frame. Since the external air cools the surface of the heating device while flowing in the installation space, the cooling performance of the heating device is improved, and the durability can be improved.

Furthermore, the external air flowing in the installation space may flow into the heating device from the end point of the air inlet passage blocked by the outer case through the second inlet part. Accordingly, external air is introduced into the second inlet part after passing through the surface of the heating device along the air inlet passage, so the cooling function by the external air can be efficiently performed.

In addition, in the present disclosure, the uneven part may be provided at a lower portion of the heating device. The uneven part protrudes toward the air inlet passage of the external air, so a contact area with the external air can expand. With heat exchange between the external air and the uneven part, the heating device can be cooled more effectively.

In addition, in the present disclosure, the heating device is arranged at the lower portion of the cooking chamber, so a reduction of the volume of the cooking chamber due to the occupied space of the heating device does not occur. Therefore, a relatively larger size of the cooking chamber can be secured, and based on the same size of the cooking chamber, the cooking appliance can be minimized.

Furthermore, in the present disclosure, the circulation device and the heating device may have different heights and be arranged in a vertical direction. Then, a flow path in the circulation device and a flow path of the heating device may form a vertically continuous flow path. Air heated by the heating device may be raised along the continuous flow path by natural draft and then may be supplied into the cooking chamber. Therefore, even when the circulation fan is not operated, heated air can be supplied to the cooking chamber, so the cooking appliance of the present disclosure can provide more various cooking modes.

At this point, in the present disclosure, the heating device is arranged at the lower portion of the circulation device, and the entire lower portion of the circulation device may overlap with the upper portion of the heating device. Then, a front-rear directional length (depth direction of the cooking chamber) of the circulation device and the heating device can be minimized, and the cooking appliance can be minimized. In addition, when the entire lower portion of the circulation device overlaps with the upper portion of the heating device, an air flow path between the heating device and the circulation device is shortened, and heat loss can be reduced.

In addition, in the present disclosure, the heating device may be arranged at the lower portion of the discharge chamber of the circulation device. Accordingly, heat inside the heating device is radiated to the discharge chamber, and air in a more heated state of the discharge chamber can be supplied to the cooking chamber. Accordingly, the heat efficiency of the cooking appliance can increase.

Furthermore, since the heating device is not located inside the cooking chamber, a component such as the fan cover, etc. doesn't need to be formed excessively larger to shield the heating device, and to match with the form of the heating device. Accordingly, the degree of freedom in the internal design of the cooking chamber can increase.

In addition, as the heating device is arranged outside the cooking chamber, radiant heat of the burner is not directly transferred to a wall surface of the cooking chamber, and the durability of the cooking appliance can increase.

Specifically, in the present disclosure, the heating device and the circulation device can be respectively coupled to the frame without being in direct contact with each other. Accordingly, conductive heat of the heating device transferred to the circulation device is significantly reduced, so the energy efficiency of the cooking appliance can increase, and the durability of the circulation device can be improved.

Furthermore, in the present disclosure, the flame hole of the burner may be formed open toward the flow path extending from the heating device to the circulation device. Accordingly, a flame generated from the burner may be concentrated to air supplied from the heating device to the circulation device and heat air in the cooking chamber quickly to increase the cooking performance.

In addition, the flame hole of the burner faces a flow path, not a wall surface of the cooking chamber or the case, so there is no risk for the surrounding components to be overheated by the burner.

Furthermore, in the present disclosure, the heating device is arranged at a position deviating from the cooking chamber, so it is possible to prevent food scraps, etc. from entering the heating device during the process of cooking food. Accordingly, the durability of the heating device can be increased.

Although embodiments have been described for illustrative purposes, those skilled in the art will appreciate that various modifications, additions and substitutions are possible, without departing from the scope and spirit as disclosed in the accompanying claims. Therefore, the embodiments described above have been described for illustrative purposes, and should not be intended to limit the technical spirit, and the scope and spirit are not limited to the embodiments. The protective scope should be interpreted by the accompanying claims, and all technical spirits within the equivalent scope should be interpreted as being included in the scope and spirit.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, for example, may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” for example, means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cooking appliance comprising:
an outer case;
a frame disposed in the outer case and in which a cooking chamber is provided;
a circulation device having a circulation chamber connecting with the cooking chamber; and
a heating device having a combustion chamber connected to the circulation chamber and comprising a burner configured to heat air flowing into the combustion chamber,
wherein the heating device has a first inlet part open toward a surface of the burner, and
a second inlet part connected to the combustion chamber is provided between the heating device and the outer case.

2. The cooking appliance of claim 1, wherein the second inlet part is provided such that the heating device and a surface of the outer case facing the heating device are spaced apart from each other.

3. The cooking appliance of claim 1, wherein the heating device is disposed along a rear edge of a lower portion of the frame in one direction, and the second inlet part is provided between the heating device and the outer case in the direction.

4. The cooking appliance of claim 1, wherein the second inlet part is provided in a direction parallel to a surface of the outer case.

5. The cooking appliance of claim 1, wherein the second inlet part extends longer than a length of the burner.

6. The cooking appliance of claim 1, wherein a connection passage is open in the frame to connect the circulation chamber and the combustion chamber to each other, and the second inlet part is disposed closer to the outer case than the connection passage.

7. The cooking appliance of claim 1, wherein a rear panel constituting the outer case is disposed opposite to an entrance of the cooking chamber, and the second inlet part is provided with the heating device and the rear panel spaced apart from each other.

8. The cooking appliance of claim 1, wherein an installation space is provided between the outer case and the frame, and the heating device is disposed in the installation space.

9. The cooking appliance of claim 8, wherein a panel opening is provided at the outer case to open the installation space, and the second inlet part is connected to the panel opening.

10. The cooking appliance of claim 8, wherein the outer case comprises a panel opening allowing the installation space to be open outward of the outer case, a shielding cover shields the panel opening, and the shielding cover has a cover hole open to be connected to the second inlet part.

11. The cooking appliance of claim 1, wherein the heating device is disposed in an installation space between the outer case and the frame, and the installation space provides a path continued from a lower portion of an opening of the cooking chamber to a rear surface portion of the outer case.

12. The cooking appliance of claim 1, wherein the heating device has a chamber opening allowing the combustion chamber to be open rearward of the heating device, and the second inlet part is connected to the chamber opening.

13. The cooking appliance of claim 1, wherein an air inlet passage is provided at a lower portion of the heating device, and the second inlet part is provided at one end of the air inlet passage blocked by the outer case.

14. The cooking appliance of claim 1, wherein the circulation device is disposed inside the frame, and the heating device is disposed outside the frame, and
wherein the heating device is disposed at a lower portion of the circulation device.

15. The cooking appliance of claim 1, wherein a connection passage is open in the frame to connect the circulation chamber and the combustion chamber to each other, and the heating device is disposed opposite to the circulation device with the connection passage located between the heating device and the circulation device.

16. The cooking appliance of claim 1, wherein a connection passage is open in the frame to connect the circulation chamber and the combustion chamber to each other, a flame guide is disposed between the burner and the connection passage, and the second inlet part and an upper space of the flame guide form a connected flow path.

17. The cooking appliance of claim 8, wherein the first inlet part is formed through a part of the heating device, and the first inlet part is connected to the installation space.

18. The cooking appliance of claim 1, wherein the circulation chamber provides a first flow path connected to the cooking chamber,
the combustion chamber provides a second flow path transferring air heated by the burner to the first flow path, and
the first flow path and the second flow path are connected to each other through a connection passage provided in a bottom surface of the frame in a height direction of the frame.

19. The cooking appliance of claim 1, wherein the heating device comprises an extension part further protruding toward the surface of the outer case than the circulation device, and the second inlet part is provided between an end of the extension part and the outer case.

20. A cooking appliance comprising:
an outer case;
a frame contained in the outer case and in which a cooking chamber is provided;
a circulation device disposed inside the frame and in which a circulation chamber connecting with the cooking chamber; and
a heating device disposed outside the frame, and in which a combustion chamber connected to the circulation chamber is provided, and comprising a burner configured to heat air flowing into the combustion chamber,
wherein the heating device has a first inlet part connecting an external part of the heating device and the combustion chamber, and
a second inlet part is provided between the heating device and the outer case along a surface of the outer case to be connected to the combustion chamber.
